(19) United States
(12) Patent Application Publication
(10) Pub. No.: US 2026/0257480 A1
(43) Pub. Date: Sep. 3, 2026

(54) LIQUID DISCHARGE UNIT AND LIQUID DISCHARGE APPARATUS

(71) Applicant: Isamu KUBO, Kanagawa (JP)

(72) Inventor: Isamu KUBO, Kanagawa (JP)

(21) Appl. No.: 19/547,735

(22) Filed: Feb. 24, 2026

(30) Foreign Application Priority Data
Feb. 28, 2025 (JP) 2025-031836

(51) Int. Cl. B41J 2/165; B41J 2/21; B41J 25/00; B41J 25/308; B41J 25/316

(52) U.S. Cl. CPC B41J 2/16511; B41J 2/2117; B41J 25/001; B41J 25/3082; B41J 25/316

(57) ABSTRACT

A liquid discharge unit includes: a first head having a first nozzle face having first nozzles on the first nozzle face, the first head configured to discharge a liquid from the first nozzles in a discharge direction, a second head having a second nozzle face having second nozzles on the second nozzle face, the second head configured to discharge a liquid from the second nozzles in the discharge direction, one carriage configured to: mounting the first head and the second head; and movable in a main scanning direction orthogonal to the discharge direction; and a first cap, in the one carriage, configured to cap the first nozzle face of the first head; and a second cap, in the one carriage, configured to cap the second nozzle face of the second head.

### CROSS-REFERENCE TO RELATED APPLICATIONS

This patent application is based on and claims priority pursuant to 35 U.S.C. § 119(a) to Japanese Patent Application No. 2025-031836, filed on Feb. 28, 2025, in the Japan Patent Office, the entire disclosure of which is hereby incorporated by reference herein.

### BACKGROUND

### Technical Field

The present embodiment relates to a liquid discharge unit and a liquid discharge apparatus.

### Related Art

As the liquid discharge apparatus, there is an inkjet printing apparatus. This type of printing apparatus includes a liquid discharge unit that performs a printing operation while moving from a home position along a guide shaft, and a cap provided separately from the liquid discharge unit.

The liquid discharge unit includes a carriage and multiple liquid discharge heads that are mounted on the carriage and discharge liquid such as ink from discharge ports to a target object. Examples of the multiple liquid discharge heads include a liquid discharge head that discharges yellow ink, a liquid discharge head that discharges magenta ink, a liquid discharge head that discharges cyan ink, and a liquid discharge head that discharges black ink. When the liquid discharge unit does not perform a printing operation, the liquid discharge unit is moved to a home position, and each liquid discharge head is covered by a cap. This protection by the cap reduces clogging of the discharge port due to drying of the discharge port.

### SUMMARY

The present disclosure described herein provides a liquid discharge unit includes: a first head having a first nozzle face having first nozzles on the first nozzle face, the first head configured to discharge a liquid from the first nozzles in a discharge direction, a second head having a second nozzle face having second nozzles on the second nozzle face, the second head configured to discharge a liquid from the second nozzles in the discharge direction, one carriage configured to: mounting the first head and the second head; and movable in a main scanning direction orthogonal to the discharge direction; and a first cap, in the one carriage, configured to cap the first nozzle face of the first head; and a second cap, in the one carriage, configured to cap the second nozzle face of the second head. The first head and the second head are independently movable between: a discharge position at which at least one of the first head or the second head discharges the liquid in the discharge direction; and a capped position at which at least one of the first cap or the second cap caps the first head or the second head.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view illustrating a printing apparatus of a first embodiment;

FIG. 2 is a plan view illustrating the printing apparatus of the first embodiment;

FIG. 3 is a front view illustrating the printing apparatus of the first embodiment;

FIG. 4 is a view illustrating an example of an arrangement of liquid discharge heads in the printing apparatus of the first embodiment;

FIG. 5 is a view illustrating an example of a nozzle surface in a liquid discharge head of the first embodiment;

FIG. 6 is a view illustrating a part of a liquid discharge unit of the first embodiment;

FIG. 7 is a view illustrating a part of the liquid discharge unit of the first embodiment in a state where the liquid discharge head is located at a discharge position;

FIG. 8 is a view illustrating a part of the liquid discharge unit of the first embodiment in a state where the liquid discharge head is located at a capped position;

FIG. 9 is a block diagram illustrating an example of a hardware configuration of the printing apparatus of the first embodiment;

FIG. 10 is a view illustrating an example of a printing operation of the printing apparatus of the first embodiment;

FIG. 11 is a view illustrating a part of a liquid discharge unit of a second embodiment in a state where a liquid discharge head is located at a discharge position;

FIG. 12 is a view illustrating a part of the liquid discharge unit of the second embodiment in a state where the liquid discharge head is located at a capped position;

FIG. 13 is a view illustrating a part of a liquid discharge unit of a third embodiment in a state where a liquid discharge head is located at a discharge position; and

FIG. 14 is a view illustrating a part of the liquid discharge unit of the third embodiment in a state where the liquid discharge head is located at a capped position.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, the present embodiment will be disclosed. The configurations of the embodiments described below and the functions and effects brought about by the configurations are merely examples. The present embodiment can be implemented by a configuration other than the configuration disclosed below. According to the present embodiment, at least one of various effects obtained by the configuration can be obtained. In the present specification, the terms “image formation,” “printing,” and “image printing” used herein may be used synonymously with each other.

In addition, the following multiple embodiments include similar components. Common reference numerals are assigned to those similar components, and redundant description is omitted.

### First Embodiment

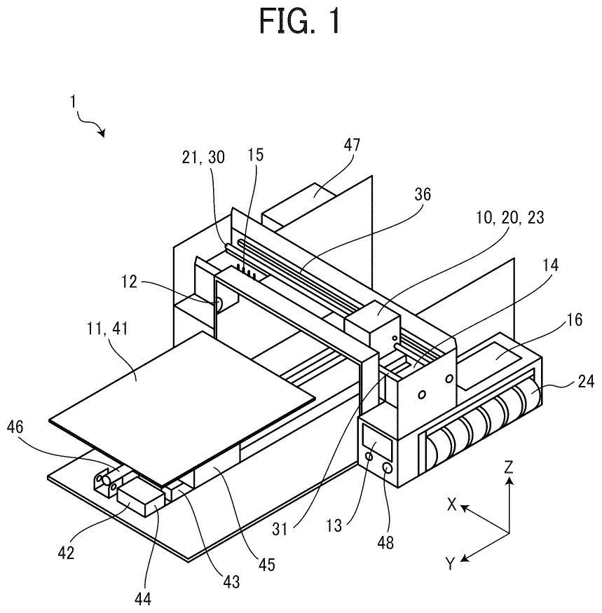

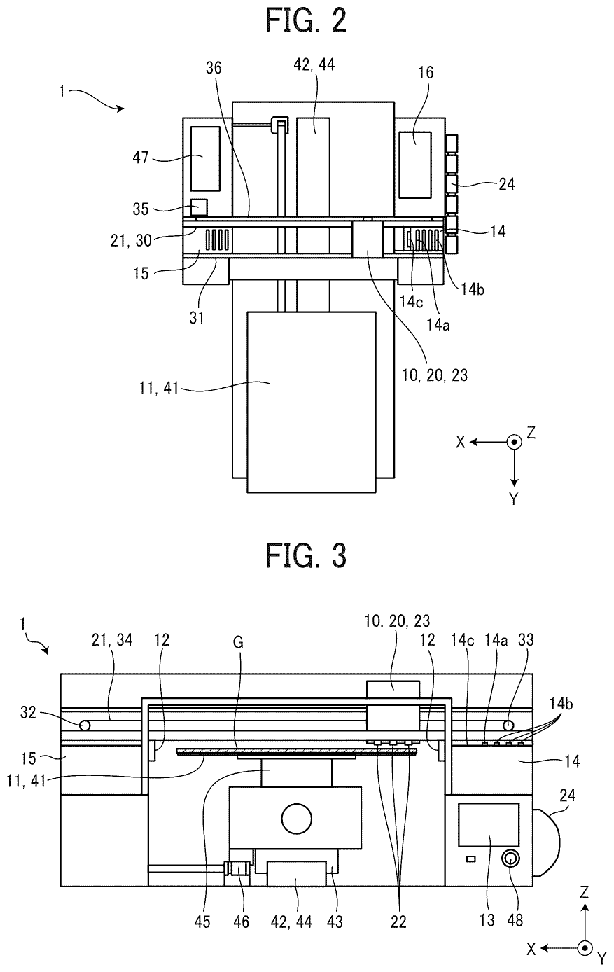

FIG. 1 is a perspective view illustrating a printing apparatus 1 of a first embodiment. FIG. 2 is a plan view illustrating the printing apparatus 1 of the first embodiment. FIG. 3 is a front view illustrating the printing apparatus 1 of the first embodiment. FIG. 3 illustrates a state in which a target object G is set in the printing apparatus 1.

The printing apparatus 1 illustrated in FIGS. 1 to 3 is a serial type inkjet printer, and is a so-called garment printer that can print on a target object G (FIG. 3) such as a textile garment.

The target object G is also referred to as a medium or a discharge target object. The printing apparatus 1 is an example of a liquid discharge apparatus.

As illustrated in the drawings, in the present specification, an X axis, a Y axis, and a Z axis are defined for convenience. The X axis, the Y axis, and the Z axis are orthogonal to each other. The X axis is along the left-right direction (width direction) of the printing apparatus 1 and along the moving direction (main scanning direction) of the carriage 23 of the printing apparatus 1. The Y axis is along the front-back direction (depth direction) of the printing apparatus 1 and also along the moving direction (sub-scanning direction) of the platen 41 of the printing apparatus 1. The Z axis is along a vertical direction of the printing apparatus 1.

In the present specification, an X direction, a Y direction, and a Z direction are defined. The X direction is a direction along the X axis and includes a +X direction indicated by an arrow of the X axis and a −X direction which is an opposite direction of the arrow of the X axis. The Y direction is a direction along the Y axis, and includes a +Y direction indicated by an arrow of the Y axis and a −Y direction which is an opposite direction of the arrow of the Y axis. The Z direction is a direction along the Z axis and includes a +Z direction indicated by an arrow of the Z axis and a −Z direction which is an opposite direction of the arrow of the Z axis. The +Z direction coincides with the upper side of the printing apparatus 1 in the vertical direction.

### Configuration of Printing Apparatus

The printing apparatus 1 includes a printing unit 10, a target object support 11, a height detection sensor 12, an operation unit 13, a maintenance unit 14, a discharge receiver 15, and a controller board 16. The controller board 16 is an example of a control unit.

The printing unit 10 can execute printing on the target object G. The printing unit 10 includes a liquid discharge unit 20 and a unit mover 21. That is, the printing apparatus 1 includes the liquid discharge unit 20. The printing apparatus 1 is an example of an apparatus equipped with the liquid discharge unit 20.

The liquid discharge unit 20 includes multiple liquid discharge heads 22 (FIG. 3), a head tank, and one carriage 23. The multiple liquid discharge heads 22 and the head tank are mounted on the carriage 23.

Each liquid discharge head 22 is an ink jet head, and discharges liquid such as ink.

By the liquid discharged from the liquid discharge head 22, printing is performed on the target object G supported by the target object support 11. The head tank temporarily stores liquid to be supplied to the liquid discharge head 22. The head tank is connected to the ink cartridge 24 via a supply tube and a supply pump. When the supply pump operates, the liquid in the head tank is supplied to the liquid discharge head 22.

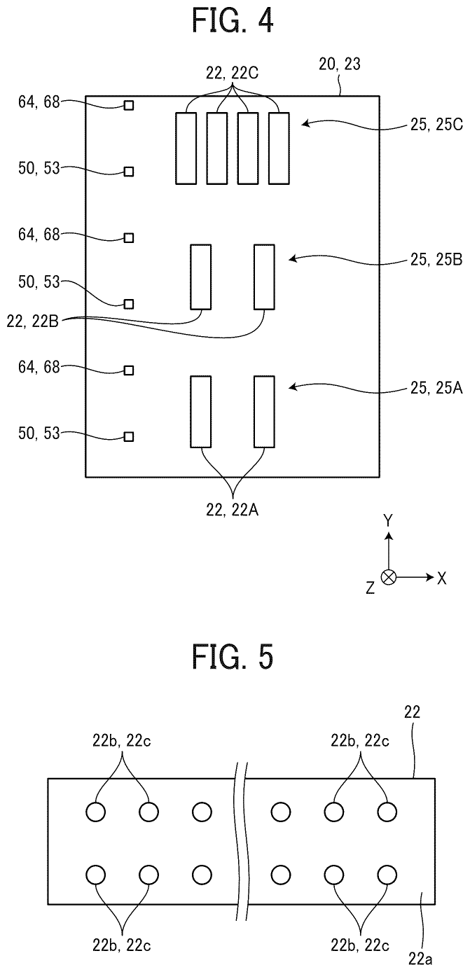

FIG. 4 is a view illustrating an example of the arrangement of the liquid discharge head 22 in the printing apparatus 1 of the first embodiment. As illustrated in FIG. 4, the multiple liquid discharge heads 22 includes, for example, two pretreatment heads 22A, two white heads 22B, and four color heads 22C. That is, the liquid discharge head 22 is a general term for the pretreatment head 22A, the white head 22B, and the color head 22C. The two pretreatment heads 22A constitute a head unit 25A.

The two white heads 22B constitute a head unit 25B. The four color heads 22C constitute a head unit 25C. Hereinafter, a head unit 25 is used as a generic name of the head unit 25A, the head unit 25B, and the head unit 25C. As described above, each of the multiple head units 25 includes one or more liquid discharge heads 22, and the multiple liquid discharge heads 22 is included in any one of the head units 25. The head unit 25 is also referred to as a head group.

The multiple liquid discharge heads 22 is mounted on the carriage 23 while being separated from each other. Specifically, the two pretreatment heads 22A are arranged with a spacing in the X direction. The two white heads 22B are arranged with a spacing in the X direction, and are arranged with a spacing on the +Y direction side with respect to the two pretreatment heads 22A. The four liquid discharge heads 22 are arranged with a spacing in the X direction, and are arranged with a spacing on the +Y direction side with respect to the two white heads 22B. That is, in the present embodiment, two rows of the pretreatment heads 22A, two rows of the white heads 22B, and four rows of the color heads 22C are arranged with a spacing in the Y direction. The two pretreatment heads 22A, the two white heads 22B, and the four color heads 22C are arranged in the +Y direction in the order of discharging liquid in the printing operation of the printing apparatus 1.

There is multiple types of liquid discharged from the multiple liquid discharge heads 22, and the liquid discharged from one liquid discharge head 22 is different from the liquid discharged from at least one of the other liquid discharge heads 22. Specifically, the two pretreatment heads 22A discharge a pretreatment liquid as the liquid. The two white heads 22B discharge a white ink for base printing as the liquid. The four color heads 22C individually discharge inks of respective colors of cyan, magenta, yellow, and black as liquid. In other words, the inks of the respective colors of cyan, magenta, yellow, and black are discharged from different color heads 22C.

The pretreatment liquid is not particularly limited as long as it can be discharged from the liquid discharge head 22, and can be appropriately selected from known pretreatment liquids, but it is preferable to contain polyvalent metal ions. The pretreatment liquid may contain other components such as a resin, for example, as necessary.

The polyvalent metal ion can be appropriately selected from known ones, and examples thereof include a calcium ion, a magnesium ion, and an aluminum ion. One type of the polyvalent metal ion may be used alone, or two or more types of the polyvalent metal ions may be used in combination.

The polyvalent metal ion can be contained in the pretreatment liquid by dissolving a water-soluble polyvalent metal salt. The polyvalent metal salt can be appropriately selected from known ones, and for example, carboxylates (acetates, lactates, and the like), sulfates, nitrates, chlorides, and thiocyanates are suitable. The polyvalent metal salt may be used alone or in combination of two or more kinds thereof. Among them, carboxylates, sulfates, nitrates, and chlorides having good solubility in water and good solubility in water-soluble organic solvents are preferable from the viewpoint of image quality such as color developability and bleed resistance and discharge reliability.

The ink is not particularly limited as long as it can be discharged from the liquid discharge head 22, and can be appropriately selected from known inks, and examples thereof include inks containing an organic solvent, water, a coloring material, a resin, an additive, and the like.

The organic solvent is not particularly limited and water-soluble organic solvents can be used. Examples thereof include polyhydric alcohols, ethers such as polyhydric alcohol alkyl ethers and polyhydric alcohol aryl ethers, nitrogen-containing heterocyclic compounds, amides, amines, and sulfur-containing compounds.

The colorant is not particularly limited, and a pigment or a dye can be used as the colorant. As the pigment, an inorganic pigment or an organic pigment can be used. Each of the pigments may be used alone or in combination of two or more kinds thereof. In addition, a mixed crystal may be used as the pigment. Usable pigments include black pigments, yellow pigments, magenta pigments, cyan pigments, white pigments, green pigments, orange pigments, glossy color pigments (for example, gold pigments and silver pigments), and metallic pigments. The dyes are not particularly limited, and acid dyes, direct dyes, reactive dyes, and basic dyes can be used. Each of these can be used alone or in combination with others.

Examples of a method of dispersing the pigment to obtain the ink include, but are not limited to, a method of introducing a hydrophilic functional group to the pigment to make the pigment self-dispersible, a method of coating a surface of the pigment with a resin to disperse the pigment, a method of dispersing the pigment by a dispersant, and the like.

By mixing a material such as water or an organic solvent with a pigment, an ink can be obtained. The ink can also be obtained by, first, preparing a pigment dispersion by mixing a pigment with water, a dispersant, or the like, and thereafter mixing the pigment dispersion with other materials such as water and an organic solvent. To obtain the pigment dispersion, water, a pigment, a pigment dispersant, and other components as necessary are mixed and dispersed and then the particle size is adjusted. The dispersion may be performed with a disperser.

The type of resin contained in the ink is not particularly limited and can be appropriately selected depending on the purpose, and examples of the resin include urethane resins, polyester resins, acrylic resins, vinyl acetate-based resins, styrene-based resins, butadiene-based resins, styrene-butadiene-based resins, vinyl chloride-based resins, acrylic styrene-based resins, and acrylic silicone-based resins. As the resin contained in the ink, resin particles made of these resins may be used. The resin particles may be dispersed in water as a dispersion medium to prepare a resin emulsion. The ink can be obtained by mixing the resin emulsion with other materials such as a colorant and an organic solvent. The resin particles may be suitably synthesized or a commercial product may be used. The resin particles may include one type or two or more types of resin particles.

Examples of the additive include a surfactant, an antifoaming agent, an antiseptic and antifungal agent, a rust inhibitor, and a pH adjusting agent.

The post-treatment liquid can be applied as necessary. The post-treatment liquid is not particularly limited as long as a transparent layer can be formed. The post-treatment liquid is obtained by selecting and mixing an organic solvent, water, a resin, a surfactant, an antifoaming agent, a pH adjusting agent, an antiseptic and antifungal agent, a rust inhibitor, and the like, for example, as necessary. The post-treatment liquid may be applied to an entire printing region formed on a medium or may be applied to a region where an ink image is formed.

FIG. 5 is a view illustrating an example of a nozzle surface 22a in the liquid discharge head 22 of the first embodiment. As illustrated in FIG. 5, each of the liquid discharge heads 22 has a nozzle surface 22a. The nozzle surface 22a is provided with multiple nozzles 22b. As an example, two rows of nozzles 22b are provided on the nozzle surface 22a. Discharge ports 22c of the nozzles 22b are open on the nozzle surface 22a. Therefore, the nozzle surface 22a is provided with two rows of discharge ports 22c. Each of the liquid discharge heads 22 discharges the above-described various liquids from the discharge ports 22c. That is, the multiple liquid discharge heads 22 is respectively provided with the discharge ports 22c through which liquid can be discharged.

The unit mover 21 illustrated in FIGS. 1 to 3 moves the liquid discharge unit 20 in the X direction. The unit mover 21 includes two guides 30 and 31 (FIGS. 1 and 2), a driving pulley 32 (FIG. 3), a driven pulley 33 (FIG. 3), a timing belt 34 (FIG. 3), and a main scanning motor 35 (FIG. 2).

As illustrated in FIGS. 1 and 2, both of the two guides 30 and 31 extend in the X direction, and are provided in parallel to each other with a spacing in the Y direction. The two guides 30 and 31 support the carriage 23 so as to be reciprocally move in the X direction. That is, the two guides 30 and 31 support the liquid discharge unit 20 so that the liquid discharge unit 20 can reciprocate in the X direction. In other words, the carriage 23 and the liquid discharge unit 20 are movable with respect to the guides 30 and 31. The guides 30 and 31 are also referred to as support members.

As illustrated in FIG. 3, the driving pulley 32 and the driven pulley 33 are provided with a spacing in the X direction. The timing belt 34 is wound around the driving pulley 32 and the driven pulley 33. The timing belt 34 is coupled to the carriage 23.

The main scanning motor 35 illustrated in FIG. 2 rotationally drives the driving pulley 32. The main scanning motor 35 can rotate in a forward rotation direction and a reverse rotation direction. When the driving pulley 32 is rotationally driven by the main scanning motor 35, the timing belt 34 moves, and the carriage 23 and the liquid discharge unit 20 are moved in the X direction. The liquid discharge unit 20 is moved in the +X direction or the −X direction according to the rotation direction of the main scanning motor 35.

As illustrated in FIG. 1, the printing unit 10 is provided with an encoder sheet 36. The encoder sheet 36 is disposed on the −Y direction side with respect to the liquid discharge unit 20 and extends along the X direction. The encoder sheet 36 and the liquid discharge head 22 face each other in the Y direction. The encoder sheet 36 is provided with multiple slits at intervals in the X direction. A reading sensor that reads the slit of the encoder sheet 36 is mounted on the carriage 23, and the position of the carriage 23 and the liquid discharge unit 20 in the X direction from a reading result of the reading sensor can be detected by the controller board 16.

The target object support 11 illustrated in FIGS. 1 to 3 moves the target object G in the Y direction while supporting the target object G (FIG. 3). The target object support 11 includes a platen 41 and a platen mover 42.

The platen 41 supports the target object G. Specifically, the platen 41 is formed in a flat plate shape, and the target object G is placed on the upper surface. The platen 41 is moved in the Y direction by the platen mover 42. The platen 41 is moved in the −Y direction and stopped below the liquid discharge unit 20.

The platen mover 42 includes a slider 43, a slide rail 44, a lifting mechanism 45, a timing belt 46, and a sub-scanning driving mechanism.

The slider 43 is supported by the slide rail 44 while supporting the platen 41 via the lifting mechanism 45. The slide rail 44 supports the slider 43 so as to be reciprocally move in the Y direction. The slider 43 is reciprocated in the Y direction by the sub-scanning driving mechanism via the timing belt 46. As the slider 43 reciprocates in the Y direction, the platen 41 reciprocates in the Y direction.

The lifting mechanism 45 can lift and lower the platen 41. In other words, the lifting mechanism 45 can adjust the height of the platen 41 (the position of the platen 41 in the Z direction). The lifting mechanism 45 includes, for example, an electric motor rotatable in a forward rotation direction and a reverse rotation direction, and a rack-and-pinion mechanism or a ball screw mechanism driven by the electric motor.

The height detection sensor 12 is, for example, a position sensor that can detect the position of the target object G in the Z direction. When the height detection sensor 12 detects that the surface of the target object G is at a height at which the surface contacts the nozzle surface 22a of the liquid discharge head 22, the controller board 16 executes control to stop the operation of the platen 41 as an error.

As illustrated in FIGS. 2 and 3, the maintenance unit 14 is disposed on one end side in the −X direction of the guides 30 and 31. The maintenance unit 14 maintains and recovers the performance of the liquid discharge head 22. Specifically, the maintenance unit 14 includes a suction cap 14a, a moisturizing cap 14b, and a wiping member 14c. The suction cap 14a caps the nozzle surface 22a of the liquid discharge head 22. A suction pump is connected to the suction cap 14a. The moisturizing cap 14b caps the nozzle surface 22a of the liquid discharge head 22 for moisturizing the nozzle surface 22a. The wiping member 14c wipes the nozzle surface 22a of the liquid discharge head 22.

The discharge receiver 15 is disposed on the other end side in the +X direction of the guides 30 and 31. The discharge receiver 15 receives liquid discharged from the liquid discharge head 22 to maintain and recover the function of the liquid discharge head 22.

The operation unit 13 illustrated in FIG. 1 accepts instructions of various operations. The printing apparatus 1 further includes a power supply unit 47 and a power button 48 that supply power to each unit of the printing apparatus 1.

### Configuration of Liquid Discharge Unit

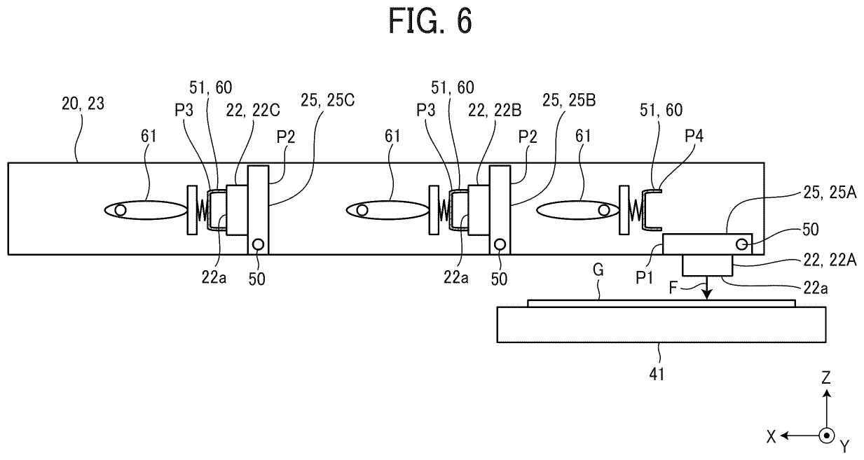

Next, details of the liquid discharge unit 20 will be described. FIG. 6 is a view illustrating a part of the liquid discharge unit 20 of the first embodiment. An arrow F illustrated in FIG. 6 and the like indicates a liquid discharge direction.

As illustrated in FIG. 6, the liquid discharge unit 20 includes multiple head movers 50 and multiple head protectors 51 in addition to the multiple liquid discharge heads 22. The multiple head movers 50 and the multiple head protectors 51 are mounted on the carriage 23. That is, in the present embodiment, the multiple liquid discharge heads 22, the multiple head movers 50, and the multiple head protectors 51 are mounted on one carriage 23. The head mover 50 and the head protector 51 are provided for each head unit 25. In other words, multiple head movers 50 and multiple head protectors 51 are provided according to the number of head units 25.

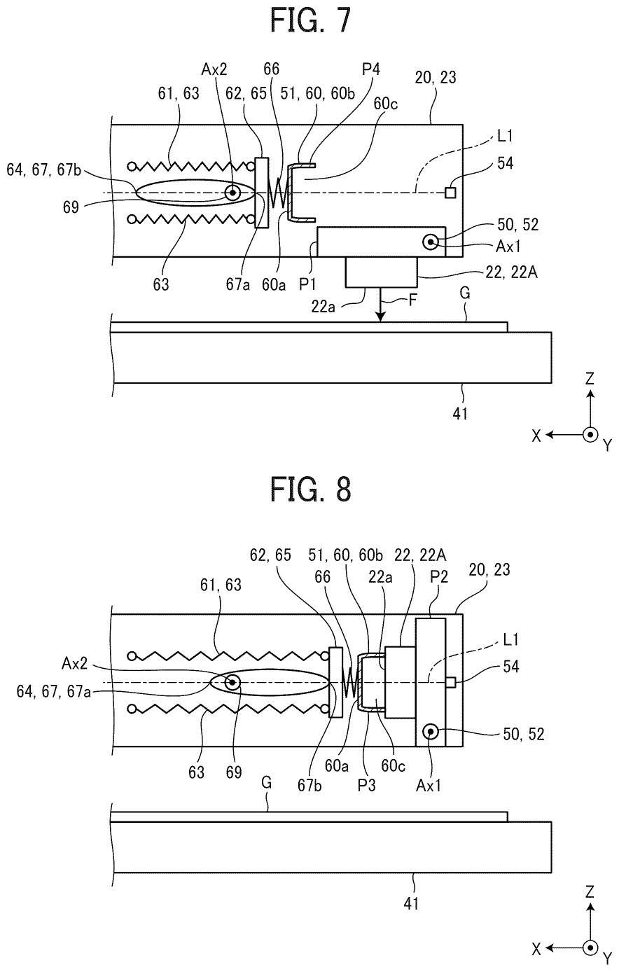

FIG. 7 is a view illustrating a part of the liquid discharge unit 20 of the first embodiment in a state where the liquid discharge head 22 is located at a discharge position P1. FIG. 8 is a view illustrating a part of the liquid discharge unit 20 of the first embodiment in a state where the liquid discharge head 22 is located at the capped position P2.

As illustrated in FIGS. 7 and 8, the head mover 50 moves the liquid discharge head 22 to a discharge position P1 (FIG. 7) and a capped position P2 (FIG. 8). As an example, the head mover 50 moves the liquid discharge head 22 to the discharge position P1 and the capped position P2 by rotating the liquid discharge head 22 about an axis Ax1 of a rotation shaft 52. The movement of the liquid discharge head 22 from the discharge position P1 to the capped position P2 is referred to as a capped movement, and the movement of the liquid discharge head 22 from the capped position P2 to the discharge position P1 is referred to as a discharge position movement. The axis Ax1 of the rotation shaft 52 extends in a direction (Y direction) intersecting (as an example, orthogonal to) the opposing direction (Z direction) of the liquid discharge head 22 and the target object G at the discharge position P1. The rotation of the liquid discharge head 22 is, for example, 90 degrees.

As illustrated in FIG. 6, the head mover 50 moves the liquid discharge head 22 independently of at least one of the other liquid discharge heads 22. That is, at least one (for example, all) of the liquid discharge heads 22 can move to the discharge position P1 and the capped position P2 different from the discharge position P1 independently of at least one of the other liquid discharge heads 22. Specifically, the two pretreatment heads 22A can move independently of the two white heads 22B and the four color heads 22C as the other liquid discharge heads 22. In this case, the two pretreatment heads 22A are first liquid discharge heads, and the two white heads 22B and the four color heads 22C are second liquid discharge heads. The two white heads 22B are movable independently of the two pretreatment heads 22A and the four color heads 22C as the other liquid discharge heads 22. In this case, the two white heads 22B are first liquid discharge heads, and the two pretreatment heads 22A and the four color heads 22C are second liquid discharge heads. The four color heads 22C are movable independently of the two pretreatment heads 22A and the two white heads 22B as the other liquid discharge heads 22. In this case, the four color heads 22C are first liquid discharge heads, and the two pretreatment heads 22A and the two white heads 22B are second liquid discharge heads. That is, in the present embodiment, each liquid discharge head 22 may be a first liquid discharge head or a second liquid discharge head. As illustrated in FIG. 7, the discharge position P1 is a position where the nozzle surface 22a (discharge ports 22c) faces the target object G, and the liquid discharge head 22 discharges the liquid from the discharge ports 22c to the target object G at the discharge position P1. At the discharge position P1, the nozzle surface 22a (discharge ports 22c) faces the −Z direction. As illustrated in FIG. 8, the capped position P2 is a position where the discharge ports 22c are separated from the target object G as compared with the case where the liquid discharge head 22 is located at the discharge position P1, and the discharge ports 22c are covered by a cap 60 of the head protector 51. At the capped position P2, the nozzle surface 22a (discharge ports 22c) faces the +X direction and does not face the target object G. At the capped position P2, all the discharge ports 22c of the liquid discharge head 22 are covered by the cap 60 of the head protector 51.

As illustrated in FIGS. 4, 7, and 8, the head mover 50 includes the rotation shaft 52 (FIGS. 7 and 8) and a drive source 53 (FIG. 4). As illustrated in FIGS. 7 and 8, the rotation shaft 52 is supported by the carriage 23 so as to be rotatable about the axis Ax1 of the rotation shaft 52 along the Y axis. The rotation shaft 52 is coupled to the liquid discharge head 22 in a state of being inserted in a hole provided in the liquid discharge head 22. The rotation shaft 52 is coupled to an end of the −X direction-side of the liquid discharge head 22 at the discharge position P1 (FIG. 7).

The rotation shaft 52 is coupled to multiple liquid discharge heads 22 provided in the head unit 25. The rotation shaft 52 is rotatable integrally with the multiple liquid discharge heads 22 provided in the head unit 25.

The drive source 53 illustrated in FIG. 4 is, for example, a motor that can rotate in the forward rotation direction and the reverse rotation direction. The drive source 53 rotationally drives the rotation shaft 52. The drive source 53 may be mounted on the carriage 23, and is not limited to the arrangement of FIG. 4.

The drive source 53 rotates the rotation shaft 52 to move the liquid discharge head 22 to the discharge position P1 (FIG. 7) and the capped position P2 (FIG. 8) by rotation. When the drive source 53 rotates the rotation shaft 52 in one direction (clockwise direction in FIG. 7) from the state where the liquid discharge head 22 is located at the discharge position P1 (FIG. 7), the liquid discharge head 22 is moved to the capped position P2 by rotation. The movement of the liquid discharge head 22 is restricted by hitting the stopper 54 at the capped position P2, and is located at the capped position P2 (FIG. 8). On the other hand, when the drive source 53 rotates the rotation shaft 52 in the other direction (counterclockwise direction in FIG. 8) from the state where the liquid discharge head 22 is located at the capped position P2, the liquid discharge head 22 is moved to the discharge position P1 by rotation. The movement of the liquid discharge head 22 is restricted by hitting the stopper at the capped position P2, and is located at the discharge position P1 (FIG. 7).

As illustrated in FIGS. 7 and 8, the head protector 51 includes a cap 60 and a cap mover 61.

The cap 60 can protect the discharge ports 22c of the liquid discharge head 22 located at the capped position P2 by covering the discharge ports 22c. Specifically, the cap 60 covers the nozzle surface 22a of the liquid discharge head 22 located at the capped position P2.

The cap 60 is a cap. The cap 60 is formed in a shape that caps and seals the discharge ports 22c (nozzle surface 22a) of the liquid discharge head 22 located at the capped position P2. Specifically, the cap 60 includes a base wall 60a and a cylindrical portion 60b. The base wall 60a constitutes an end of the cap 60 on the +X direction side, and is formed in a flat plate shape. The cylindrical portion 60b extends from an outer edge of the base wall 60a toward the −X direction side.

In the cap 60, a recessed space 60c is formed by the base wall 60a and the cylindrical portion 60b. The space 60c is open in the −X direction. The cap 60 covers all the discharge ports 22c of the liquid discharge head 22 in a state (FIG. 8) where a distal end (end on the −X direction side) of the cylindrical portion 60b and the nozzle surface 22a of the liquid discharge head 22 are in contact with each other. At this time, the space 60c is secured between the inner surface of the cap 60 and the discharge ports 22c.

The discharge ports 22c (nozzle surface 22a) of the liquid discharge head 22 capped by the cap 60 are not in contact with the ambient air outside the cap 60. Thus, since the discharge ports 22c (nozzle surface 22a) of the liquid discharge head 22 are blocked from the ambient air, evaporation of the liquid at the discharge ports 22c is reduced, and drying inside the discharge ports 22c and the liquid discharge head 22, and thickening and adhesion of the liquid therein are reduced as compared with the case where capping is not performed by the cap 60.

Here, the cap 60 may have a space in which a moisturizing agent including a cleaning liquid can be filled. By capping the liquid discharge head 22 with the cap 60 in a state where the cap 60 is filled with the moisturizing agent, the nozzle surface 22a including the nozzle 22b can be brought into a moisturizing state. Thus, evaporation of the liquid is more reliably reduced, and thickening and adhesion can be reduced. In this case, the cleaning of the nozzle surface 22a can be performed at the same time by filling the cap 60 so that the cleaning liquid comes into contact with the nozzle surface 22a when the nozzle surface 22a is capped with the cap 60. With this cleaning liquid, an adhering material such as ink adhered to the nozzle surface 22a can be melted, which is effective in recovering the liquid discharging performance of the discharge ports 22c.

The cap mover 61 moves the cap 60 to a capping position P3 (FIG. 8) and an open position P4 (FIG. 7). Specifically, the cap mover 61 moves the cap 60 to the capping position P3 and the open position P4 by reciprocating the cap 60 on a straight line L1 extending in the X direction. The capping position P3 is a position where the cap 60 covers the discharge ports 22c of the liquid discharge head 22 located at the capped position P2. The open position P4 is a position on the −X direction side with respect to the capping position P3, and is a position where the cap 60 is separated from the liquid discharge head 22 at the capped position P2 as compared with the case of the capping position P3. When the cap 60 is located at the open position P4, the discharge ports 22c of the liquid discharge head 22 are in an open state without being covered by the cap 60. The open position P4 is a position at which the liquid discharge head 22 and the cap 60 do not interfere with each other when the liquid discharge head 22 moves by rotation between the discharge position P1 and the capped position P2. The movement of the cap 60 from the capping position P3 to the open position P4 is referred to as an open position movement, and the movement of the cap 60 from the open position P4 to the capping position P3 is referred to as a capping movement.

The cap mover 61 includes a head support 62, two elastic members 63, and a driver 64.

The head support 62 is provided for each cap 60. The head support 62 includes a base member 65 and an elastic member 66. The base member 65 is provided to be movable in the X direction on the straight line L1. The cap 60 is connected to the base member 65 via the elastic member 66. In other words, the elastic member 66 is interposed between the base member 65 and the cap 60. The elastic member 66 presses the cap 60 at the capping position P3 against the liquid discharge head 22 located at the capped position P2 by elastic force (FIG. 8). The elastic member 66 is, for example, a coil spring. The elastic member 66 is not limited to the above.

One end of an elastic member 63 is coupled to the carriage 23, and the other end of the elastic member 63 is coupled to the base member 65. That is, the other end of the elastic member 63 is coupled to the cap 60 via the base member 65 and the elastic member 66. The elastic member 63 acts as a tension spring. The two elastic members 63 can move the cap 60 from the capping position P3 to the open position P4 by elastic force via the base member 65 and the elastic member 66.

The driver 64 moves the cap 60 from the open position P4 to the capping position P3 against the elastic force of the two elastic members 63. Specifically, as illustrated in FIGS. 4, 7, and 8, the driver 64 includes a cam 67 (FIGS. 7 and 8) and a drive source 68 (FIG. 4) that generates a driving force. As illustrated in FIGS. 7 and 8, the cam 67 is provided for each cap 60. The cam 67 is supported by the carriage 23 via the rotation shaft 69 so as to be rotatable about the axis Ax2. The axis Ax2 is an axis of the rotation shaft 69 and is along the Y axis.

One rotation shaft 69 is provided in each head unit 25, and is coupled to multiple cams 67 included in the head unit 25. The cam 67 and the rotation shaft 69 rotate integrally. The base member 65 is pressed against the cam 67 by the elastic force of the elastic members 63.

The cam 67 is a plate cam and has two crests 67a and 67b. The distance between the crest 67a and the axis Ax2 is shorter than the distance between the crest 67b and the axis Ax2. In a state where the crest 67a is in contact with the base member 65, the cap 60 is located at the open position P4 (FIG. 7). In a state where the crest 67b is in contact with the base member 65, the cap 60 is located at the capping position P3 (FIG. 8).

As illustrated in FIG. 4, one drive source 68 is provided in each head unit 25. The drive source 68 is, for example, a motor. The drive source 68 rotationally drives the rotation shaft 69.

The drive source 68 may be mounted on the carriage 23, and is not limited to the arrangement of FIG. 4.

The drive source 68 rotates the cam 67 via the rotation shaft 69 to move the cap 60 to the capping position P3 (FIG. 8) and the open position P4 (FIG. 7).

When the drive source 68 rotates the cam 67 against the elastic force of the elastic members 63 by the driving force from the state in which the cap 60 is located at the open position P4 (FIG. 7), the cam 67 pushes the base member 65 in the −X direction. Thus, the cap 60 moves on the straight line L1 to the capping position P3 together with the base member 65. That is, the driver 64 performs the capping movement of the cap 60 by the driving force of the drive source 68 against the elastic force of the elastic members 63. At the capping position P3, the crest 67b of the cam 67 comes into contact with the base member 65, and the elastic member 66 presses the cap 60 against the nozzle surface 22a of the liquid discharge head 22 (FIG. 8).

On the other hand, when the drive source 68 rotates the cam 67 from the state where the cap 60 is located at the capping position P3 (FIG. 8), the base member 65 is pulled in the +X direction by the elastic force of the two elastic members 63. Thus, the cap 60 moves on the straight line L1 to the open position P4 together with the base member 65. That is, the elastic members 63 perform the open position movement of the cap 60 by elastic force.

### Controller Board

Next, the controller board 16 illustrated in FIG. 1 and the like will be described. The controller board 16 executes various types of control. For example, the controller board 16 executes control for adjusting the height of the platen 41 by the lifting mechanism 45 according to the thickness of the target object G. When the height detection sensor 12 detects that the surface of the target object G is at a height at which the surface of the target object G is in contact with the nozzle surface 22a of the liquid discharge head 22, the controller board 16 executes control to stop the operation of the platen 41 as an error. The controller board 16 executes control to cause the liquid discharge head 22 to discharge the liquid such as the ink in timing with the discharge position for discharging the liquid based on the position of the carriage 23 obtained from the reading result of the reading sensor mounted on the carriage 23. The controller board 16 is a unit that processes and controls operation (output) of a motor, a solenoid, or the like and an input signal of a sensor or the like, and is controlled based on installed software. The controller board 16 also performs, for example, print control of print data transmitted from an external device, and print control processing of reading a USB memory or recorded print data.

### Hardware Configuration Example of Printing Apparatus

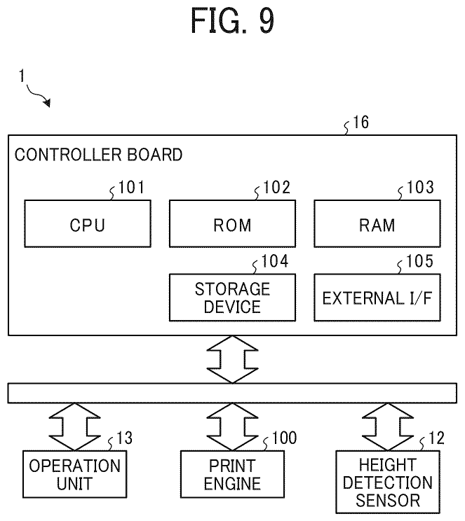

Next, a hardware configuration example of the printing apparatus 1 of the embodiment will be described with reference to FIG. 9. FIG. 9 is a block diagram illustrating an example of a hardware configuration of the printing apparatus 1.

A height detection sensor 12, an operation unit 13, and a print engine 100 are connected to the controller board 16.

The print engine 100 includes a liquid discharge unit 20 and the like, and forms an image on the target object G. When an image is formed on the target object G, a platen 41 on which the target object G is placed is attached to the print engine 100. Then, the print engine 100 discharges liquid such as ink from the liquid discharge head 22 to the target object G according to a print instruction input from the operation unit 13 or an external device. Thus, an image is formed on the target object G.

The operation unit 13 receives an input such as a print instruction and a heating instruction from a user. In addition, the operation unit 13 displays various information such as a status of the printing apparatus 1 such as the print engine 100 and a printing result by the printing apparatus 1.

The controller board 16 is configured as a computer or the like including a central processing unit (CPU) 101, a read only memory (ROM) 102, a random access memory (RAM) 103, a storage device 104, and an external interface (an external I/F in FIG. 9) 105.

The CPU 101 uses the RAM 103 as a work area, and executes a program stored in the ROM 102 or the like, for example. Thus, the CPU 101 controls input and output of various types of information in the operation unit 13. In addition, the CPU 101 performs a printing process including an image forming process and the like on the target object G as a printing target in accordance with a user's instruction input from the operation unit 13, an external device, or the like.

In the printing process, the CPU 101 causes the print engine 100 to discharge liquid such as ink onto the target object G as a printing target to form an image.

The storage device 104 is, for example, a hard disk drive (HDD), a solid state drive (SSD), or the like, and is used as an auxiliary storage area. The storage device 104 stores a garment catalog holding conditions set for each type of the target object G.

The external interface 105 enables communication between the printing apparatus 1 and an external device such as external equipment. Communication between the printing apparatus 1 and the external device such as external equipment may be performed according to, for example, an Ethernet (registered trademark) standard, a universal serial bus (USB) (registered trademark) standard, or the like.

### Printing Operation

The controller board 16 controls the liquid discharge unit 20. In the printing operation of the printing apparatus 1, the controller board 16 drives the liquid discharge heads 22 of the head units 25 to cause the liquid discharge heads 22 to discharge liquid. The multiple liquid discharge heads 22 performs a printing operation of discharging liquid onto the target object G. The multiple head units 25 selectively perform a discharge operation of discharging liquid from the liquid discharge head 22 in the printing operation.

Specifically, in the printing operation, first, the pretreatment head 22A of the head unit 25A discharges the pretreatment liquid, then the white head 22B of the head unit 25B discharges the white ink, and then the color head 22C of the head unit 25C individually discharges the ink of each color of cyan, magenta, yellow, and black. That is, the printing operation includes, as multiple steps of discharging the liquid onto the target object G, a step of discharging the pretreatment liquid by the pretreatment head 22A of the head unit 25A, a step of discharging the white ink by the white head 22B of the head unit 25B, and a step of individually discharging the ink of each color of cyan, magenta, yellow, and black by the color head 22C of the head unit 25C. If the discharge ports 22c of the liquid discharge head 22 that does not discharge liquid are exposed during this printing operation, the discharge ports 22c may dry. Accordingly, in the present embodiment, the liquid discharge head 22 that does not discharge liquid is covered with the cap 60. Specifically, in the present embodiment, in each step of the printing operation, the liquid discharge head 22 that discharges liquid is located at the discharge position P1, and the liquid discharge head 22 that does not discharge liquid is located at the capped position P2.

Hereinafter, an example of a printing operation of the printing apparatus 1 of the present embodiment will be described. The following is an example of printing on a fabric such as a T-shirt as the target object G.

First, the target object G is placed on the platen 41 so as not to form wrinkles (irregularities). Thereafter, the slider 43 pulls the platen 41 to the lower side (−Z direction side) of the liquid discharge unit 20 in the printing apparatus 1 by operating the operation unit 13. Then, the platen 41 supporting the target object G moves to a print start position (−Y direction side in FIG. 1).

When the retraction of the platen 41 is completed, the printing apparatus 1 enters a standby state for reception of print data. When the printing apparatus 1 receives print data from an external device such as an information processing apparatus, a printing operation check is performed, and the printing operation is started. The information processing apparatus is, for example, a computer such as a personal computer or a smartphone. In a case where print data is accumulated on the controller board 16 in advance, the print data is selected by the operation unit 13 to start the printing operation.

When the printing operation is started, the platen 41 is moved to the printing start position by the slider 43. Thereafter, the liquid discharge unit 20 is guided by the guides 30 and 31 to move in the +X direction (main scanning direction) while reading the encoder sheet 36. During this movement, the liquid discharge head 22 discharges the liquid to one surface of the target object G set on the platen 41. In accordance with the operation of the liquid discharge head 22, the platen 41 is moved in the +Y direction (from the upstream side on the far side to the downstream side on the near side in FIG. 1) by the platen mover 42, and printing is performed.

In this way, the movement of the carriage 23 (liquid discharge unit 20) and the discharge of the liquid from the liquid discharge head 22 are performed, and printing for one row is performed. After printing for one line, the slider 43 moves the platen 41 by one line. By repeating one scan of the carriage 23 and the intermittent movement of the slider 43, printing is performed on a desired region on the surface of the target object G. After the printing operation, the platen 41 is returned in the +Y direction, and the liquid discharge head 22 is capped by the moisturizing cap 14b of the maintenance unit 14, thereby finishing the printing.

After the printing is completed, the target object G is taken out from the platen 41, post-treatment operation of heating and fixing is performed using a heat press machine or the like, and a series of operations and tasks of the printing apparatus 1 are completed.

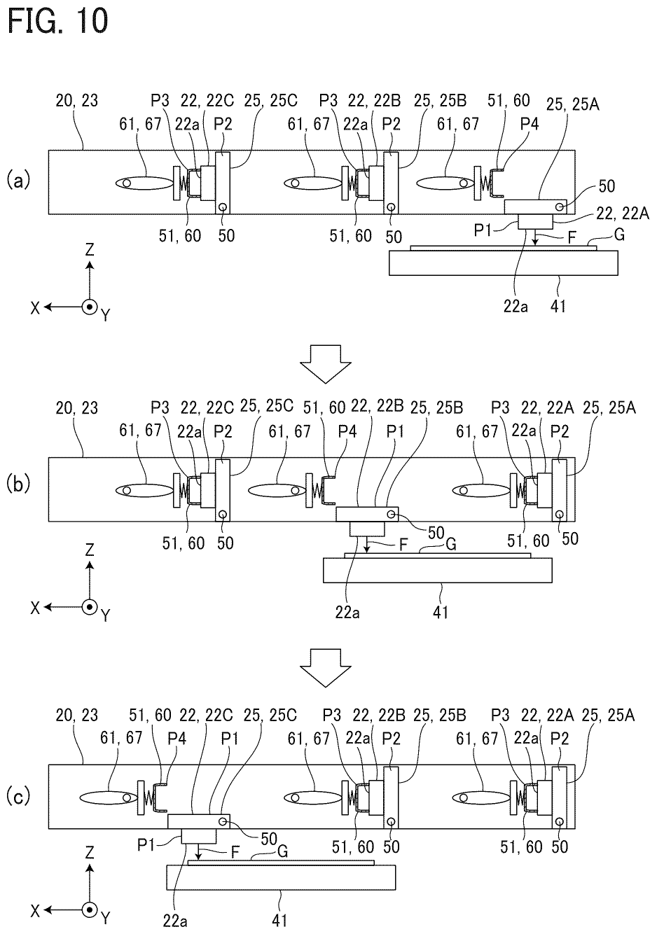

Next, an operation in the liquid discharge unit 20 in the printing operation will be described with reference to FIG. 10(a) to 10(c). FIG. 10(a) to 10(c) are views illustrating an example of a printing operation of the printing apparatus 1 of the first embodiment. The following operation of the liquid discharge unit 20 is performed under the control of the controller board 16.

As illustrated in FIG. 10(a), first, each pretreatment head 22A of the head unit 25A discharges the pretreatment liquid onto the target object G. At this time, the pretreatment head 22A is located at the discharge position P1, and the cap 60 provided with respect to the pretreatment head 22A is located at the open position P4. The white head 22B of the head unit 25B and the color head 22C of the head unit 25C are each positioned at the capped position P2, and the cap 60 provided for each of the white head 22B and the color head 22C is positioned at the capping position P3 to protect the white head 22B and the color head 22C. Thus, drying of the discharge ports 22c of the white head 22B and the color head 22C is reduced. At this time, since the discharge ports 22c of the pretreatment head 22A discharge the pretreatment liquid, it is difficult to dry.

Next, as illustrated in FIG. 10(b), each white head 22B of the head unit 25B is moved to the discharge position P1 to discharge the white ink onto the target object G. At this time, the cap 60 provided with respect to the white head 22B is moved to the open position P4. At this time, the pretreatment head 22A of the head unit 25A is moved to the capped position P2. In addition, the cap 60 provided with respect to the pretreatment head 22A is moved to the capping position P3 to cover the pretreatment head 22A. The color head 22C of the head unit 25C is located at the capped position P2 and is protected by the cap 60. Thus, drying of the discharge ports 22c of the pretreatment head 22A and the color head 22C is reduced. At this time, since the discharge ports 22c of the white head 22B discharge the white ink, it is difficult to dry.

Next, as illustrated in FIG. 10(c), the color head 22C of the head unit 25C is moved to the discharge position P1, and individually discharges the ink of each color of cyan, magenta, yellow, and black to the target object G. At this time, the cap 60 provided with respect to the color head 22C is moved to the open position P4. At this time, the white head 22B of the head unit 25B is moved to the capped position P2. In addition, the cap 60 provided with respect to the white head 22B is moved to the capping position P3 and covers the white head 22B. The pretreatment head 22A of the head unit 25A is located at the capped position P2 and is protected by the cap 60. Thus, drying of the discharge ports 22c of the pretreatment head 22A and the white head 22B is reduced. At this time, since the discharge ports 22c of the color head 22C individually discharge inks of respective colors of cyan, magenta, yellow, and black, it is difficult to dry.

As described above, the head mover 50 positions the liquid discharge head 22 of the head unit 25 at the discharge position P1 when the head unit 25 provided with the head mover 50 performs the discharge operation. On the other hand, when the other head unit 25 performs the discharge operation, the head mover 50 positions the liquid discharge head 22 of the head unit 25 provided with the head mover 50 at the capped position P2.

### Overview

As described above, the liquid discharge unit 20 of the present embodiment includes the one carriage 23, the multiple liquid discharge heads 22, and the cap 60. The carriage 23 is movable with respect to the guides 30 and 31 included in the printing apparatus 1 (apparatus) on which the liquid discharge unit 20 is mounted. Each of the multiple liquid discharge heads 22 is provided with the discharge ports 22c through which liquid can be discharged. The multiple liquid discharge heads 22 is mounted on the carriage 23. The multiple liquid discharge heads 22 discharges liquid from the discharge ports 22c to the target object G at the discharge position P1. The cap 60 is provided in the carriage 23 and can cover the discharge ports 22c of the at least one liquid discharge head 22. A first liquid discharge head among the multiple liquid discharge heads 22 can move independently of a second liquid discharge head different from the first liquid discharge head among the multiple liquid discharge heads 22 to the discharge position P1 and the capped position P2 that is a position different from the discharge position P1 and at which the discharge ports 22c are covered by the cap 60. In the present embodiment, when the two pretreatment heads 22A are the first liquid discharge heads, the two white heads 22B and the four color heads 22C are the second liquid discharge heads. When the two white heads 22B are the first liquid discharge heads, the two pretreatment heads 22A and the four color heads 22C are the second liquid discharge heads. When the four color heads 22C are the first liquid discharge heads, the two pretreatment heads 22A and the two white heads 22B are the second liquid discharge heads. In the following description, the first liquid discharge head and the second liquid discharge head are any of the above.

With such a configuration, the first liquid discharge head among the multiple liquid discharge heads 22 is movable to the discharge position P1 and the capped position P2 independently of the second liquid discharge head among the multiple liquid discharge heads 22. Thus, when the first liquid discharge head does not discharge ink in the printing operation, the first liquid discharge head can be moved to the capped position P2 and covered by the cap 60. Therefore, it is possible to reduce drying of the discharge ports 22c of the liquid discharge head 22 at the time of discharging liquid.

The liquid discharge unit 20 includes the head mover 50. The head mover 50 is mounted on the carriage 23. The head mover 50 moves the first liquid discharge head to the discharge position P1 and the capped position P2 independently of the second liquid discharge head.

With such a configuration, the configuration of the printing apparatus 1 can be simplified as compared with a configuration in which the head mover 50 is provided in a carriage or the like different from the liquid discharge unit 20 and moves in synchronization with the liquid discharge unit 20.

The multiple liquid discharge heads 22 performs a printing operation including multiple steps of discharging liquid onto the target object G. The head mover 50 positions the first liquid discharge head at the discharge position P1 in a case where the first liquid discharge head discharges liquid, and positions the first liquid discharge head at the capped position P2 in a case where the first liquid discharge head does not discharge liquid.

With such a configuration, by the operation of the head mover 50, in a case of a step in which the first liquid discharge head does not discharge ink in the printing operation, the first liquid discharge head can be moved to the capped position P2 and covered by the cap 60. Therefore, it is possible to reduce drying of the discharge ports 22c of the liquid discharge head 22 at the time of discharging liquid.

The liquid discharge unit 20 includes multiple head units 25. Each of the multiple head units 25 includes one or more liquid discharge heads 22. The multiple liquid discharge heads 22 is included in any one of the head units 25, and performs a printing operation of discharging liquid onto the target object G. The multiple head units 25 selectively perform a discharge operation of discharging liquid from the liquid discharge head 22 in the printing operation. The head mover 50 is provided in the head unit 25 including the first liquid discharge head. The head mover 50 positions the first liquid discharge head at the discharge position P1 when the head unit 25 provided with the head mover 50 performs the discharge operation. On the other hand, when the other head unit 25 performs the discharge operation, the head mover 50 positions the first liquid discharge head at the capped position P2.

With such a configuration, it is possible to reduce drying of the discharge ports 22c of the liquid discharge head 22 of the head unit 25 that does not perform the discharge operation.

The head mover 50 moves the first liquid discharge head to the discharge position P1 and the capped position P2 by rotating the first liquid discharge head about an axis Ax1 extending in a direction (Y direction) intersecting the opposing direction (Z direction) of the first liquid discharge head and the target object G at the discharge position P1.

With such a configuration, the liquid discharge head 22 can be moved to the discharge position P1 and the capped position P2 by rotation. With such a configuration, since the capping position P3 of the cap 60 can be set on the outer side between the liquid discharge head 22 and the target object G (platen 41), it is not necessary to increase the distance between the liquid discharge head 22 at the discharge position P1 and the target object G (platen 41). Therefore, it is possible to reduce deterioration in quality of the print image due to distortion of the print image.

The head mover 50 includes the rotation shaft 52 and the drive source 53. The rotation shaft 52 is coupled to the first liquid discharge head and is rotatable integrally with the first liquid discharge head about the axis Ax1. The drive source 53 rotates the rotation shaft 52 to rotate the first liquid discharge head to the discharge position P1 and the capped position P2.

With such a configuration, the first liquid discharge head can be rotated with a relatively simple configuration.

The liquid discharge unit 20 includes the cap mover 61. The cap mover 61 moves the cap 60 to the capping position P3 at which the cap 60 covers the discharge ports 22c of the first liquid discharge head located at the capped position P2 and the open position P4 at which the cap 60 is separated from the liquid discharge head 22 at the capped position P2 as compared with the case of the capping position P3.

With such a configuration, it is possible to prevent the cap 60 from hindering the movement of the liquid discharge head 22.

The cap mover 61 includes the elastic members 63 and the driver 64. The elastic members 63 perform one of the open position movement of the cap 60 from the capping position P3 to the open position P4 and the capping movement of the cap 60 from the open position P4 to the capping position P3 by elastic force. The driver 64 includes the drive source 53 that generates driving force. The driver 64 performs the other of the open position movement of the cap 60 and the capping movement of the cap 60 by the driving force against the elastic force.

With such a configuration, the power for the movement of the cap 60 can be shared by the elastic members 63 and the drive source 53.

The cap mover 61 includes the elastic member 66. The elastic member 66 presses the cap 60 at the capping position P3 against the liquid discharge head 22 located at the capped position P2 by elastic force.

With such a configuration, the cap 60 can be brought into close contact with the liquid discharge head 22.

The liquid discharged from one liquid discharge head 22 is different from the liquid discharged from at least one of the other liquid discharge heads 22.

With such a configuration, since multiple types of liquids can be discharged from the multiple liquid discharge heads 22, various printing can be performed.

Here, in the case of a configuration in which the liquid discharge head 22 is fixed to the carriage 23 at the discharge position P1, the shutter member is slid between the liquid discharge head 22 and the target object G, and the discharge ports 22c are covered with the shutter member, it is necessary to widen the spacing between the discharge ports 22c and the target object G (platen 41) for the shutter member. Therefore, in this configuration, the spacing between the discharge ports 22c and the target object G (platen 41) becomes wide, and the quality of the print image may be deteriorated due to distortion of the print image.

On the other hand, in the present embodiment, the discharge position P1 is a position where the discharge ports 22c face the target object G, and the capped position P2 is a position where the discharge ports 22c are separated from the target object G as compared with the case where the liquid discharge head 22 is located at the discharge position P1.

With such a configuration, since the discharge ports 22c are located at a position more distant from the target object G than in the case where the liquid discharge head 22 is located at the discharge position P1, it is not necessary to widen the spacing between the discharge position P1 and the target object G (platen 41). In other words, since the discharge position P1 can be set at a position relatively close to the target object G, the spacing between the discharge ports 22c and the target object G (platen 41) at the discharge position P1 can be made relatively narrow. For example, the spacing between the discharge ports 22c and the target object G (platen 41) at the discharge position P1 can be set to a narrow spacing to the extent that the liquid discharge head 22 and the target object G (platen 41) do not come into contact with each other. Therefore, according to the present embodiment, it is possible to reduce deterioration in quality of the print image due to distortion of the print image.

The printing apparatus 1 (liquid discharge apparatus) includes a liquid discharge unit 20 and a controller board 16 (control unit). The controller board 16 controls the liquid discharge unit 20.

With such a configuration, it is possible to reduce the drying of the discharge ports 22c of the liquid discharge unit 20 provided in the printing apparatus 1 when discharging the liquid.

In the present embodiment, the elastic member 63 moves the cap 60 from the capping position P3 to the open position P4 by elastic force, and the driver 64 moves the cap 60 from the open position P4 to the capping position P3. However, the present embodiment is not limited thereto. For example, the driver 64 may move the cap 60 from the capping position P3 to the open position P4, and the elastic member 63 may move the cap 60 from the open position P4 to the capping position P3 by elastic force.

### Second Embodiment

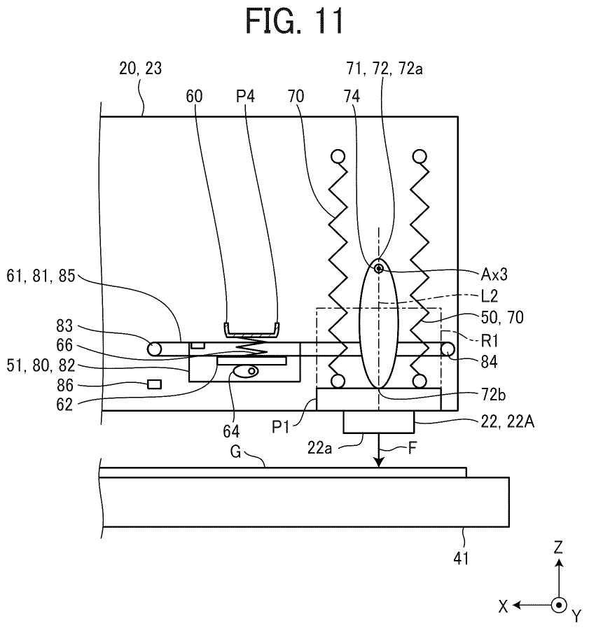

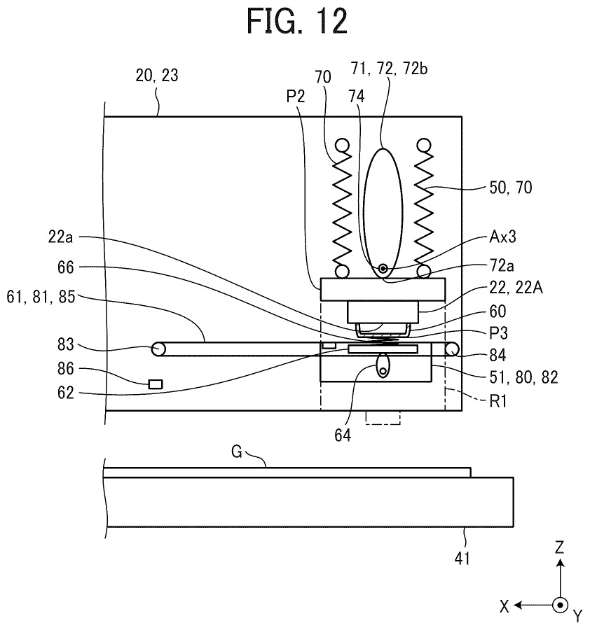

FIG. 11 is a view illustrating a part of the liquid discharge unit 20 of the second embodiment in a state where the liquid discharge head 22 is located at the discharge position P1. FIG. 12 is a view illustrating a part of the liquid discharge unit 20 of the second embodiment in a state where the liquid discharge head 22 is located at the capped position P2.

As illustrated in FIGS. 11 and 12, the present embodiment is different from the first embodiment in the configuration of the liquid discharge unit 20. Hereinafter, differences from the first embodiment in the present embodiment will be mainly described.

In the present embodiment, the head mover 50 moves the liquid discharge head 22 to the discharge position P1 and the capped position P2 by reciprocating the liquid discharge head 22 on a straight line L2 (FIG. 11) extending in the Z direction. The head mover 50 includes two elastic members 70 and a driver 71. The capped position P2 (FIG. 12) of the present embodiment is a position on the +Z direction side with respect to the discharge position P1 (FIG. 11). In the present embodiment, the nozzle surface 22a (discharge ports 22c) of the liquid discharge head 22 faces the target object G at both the discharge position P1 and the capped position P2.

One end of the elastic member 70 is coupled to the carriage 23, and the other end of the elastic member 70 is coupled to the liquid discharge head 22. The elastic member 70 acts as a tension spring. The two elastic members 70 move the liquid discharge head 22 from the discharge position P1 (FIG. 11) to the capped position P2 (FIG. 12) by elastic force.

The driver 71 moves the liquid discharge head 22 from the capped position P2 (FIG. 12) to the discharge position P1 (FIG. 11) against the elastic force of the elastic member 70. Specifically, the driver 71 includes a cam 72 and a drive source 53 (FIG. 4) that generates driving force. The cam 72 is supported by the carriage 23 via a rotation shaft 74 so as to be rotatable about the axis Ax3. The axis Ax3 is along the Y axis. The rotation shaft 74 is coupled to multiple cams 72 provided in the head unit 25. The rotation shaft 74 rotates integrally with the multiple cams 72 provided in the head unit 25. The liquid discharge head 22 is pressed against the cam 72 by elastic force of the elastic member 70. The cam 72 is a plate cam and has two crests 72a and 72b. The distance between the crest 72a and the axis Ax3 is shorter than the distance between the crest 72b and the axis Ax3. In a state where the crest 72a is in contact with the liquid discharge head 22, the liquid discharge head 22 is located at the capped position P2 (FIG. 12). In a state where the crest 72b is in contact with the liquid discharge head 22, the liquid discharge head 22 is located at the discharge position P1 (FIG. 11).

The drive source 53 is similar to that of the first embodiment. However, in the present embodiment, the drive source 53 rotationally drives the rotation shaft 74.

The drive source 53 rotates the cam 72 via the rotation shaft 74 to move the liquid discharge head 22 to the discharge position P1 and the capped position P2.

When the drive source 68 rotates the cam 72 against the elastic force of the elastic member 70 by the driving force from the state where the liquid discharge head 22 is located at the capping position P3 (FIG. 12), the cam 72 pushes the liquid discharge head 22. Thus, the liquid discharge head 22 moves to the discharge position P1 in a posture in which the nozzle surface 22a faces the −Z direction (FIG. 11). That is, the driver 71 moves the discharge position of the liquid discharge head 22 by the driving force of the drive source 53 against the elastic force of the elastic member 70.

On the other hand, when the drive source 53 rotates the cam 72 from the state where the liquid discharge head 22 is located at the discharge position P1 (FIG. 11), the liquid discharge head 22 is pulled to the capped position P2 by the elastic force of the elastic member 70. Thus, the liquid discharge head 22 moves to the capped position P2 in a posture in which the nozzle surface 22a faces the −Z direction. That is, the elastic member 70 performs the capping movement of the liquid discharge head 22 by elastic force.

The head protector 51 of the present embodiment includes a movable unit 80 and a unit mover 81.

The movable unit 80 includes a cap 60, an elastic member 66, a driver 64, and a support member 82. The support member 82 supports the cap 60, the elastic member 66, and the driver 64. The movable unit 80 is provided to be movable in the X direction.

The unit mover 81 can move the movable unit 80 to the inside of a movement region R1 of the liquid discharge head 22 (FIG. 12) and the outside of the movement region R1 of the liquid discharge head 22 (FIG. 11).

Specifically, the unit mover 81 includes a driving pulley 83, a driven pulley 84, a belt 85, and a drive source 86.

The driving pulley 83 and the driven pulley 84 are provided with a spacing in the X direction. The belt 85 is wound around the driving pulley 83 and the driven pulley 84. The belt 85 is coupled to the support member 82 of the movable unit 80.

The drive source 86 is, for example, a motor that can rotate in a forward rotation direction and a reverse rotation direction. The drive source 86 rotationally drives the driving pulley 83. The drive source 53 may be mounted on the carriage 23, and is not limited to the arrangements of FIGS. 11 and 12. When the driving pulley 83 is rotationally driven by the drive source 86, the belt 85 moves, and the movable unit 80 is moved in the X direction. The movable unit 80 is moved in the +X direction or the −X direction according to the rotation direction of the drive source 86.

When the liquid discharge head 22 is located at the discharge position P1 (FIG. 11), the movable unit 80 is located outside the movement region R1 of the liquid discharge head 22. From this state, as the driver 64 moves the liquid discharge head 22 to the capped position P2, the unit mover 81 moves the movable unit 80 to the inside of the movement region R1 of the liquid discharge head 22. Thus, the liquid discharge head 22 is covered with the cap 60.

As described above, in the present embodiment, the head mover 50 moves the first liquid discharge head to the discharge position P1 and the capped position P2 by reciprocating the first liquid discharge head on the straight line L2.

With such a configuration, the liquid discharge head 22 can be moved to the discharge position P1 and the capped position P2 by reciprocating movement on the straight line L2.

The head mover 50 includes the elastic member 70 and the driver 71. The elastic member 70 performs one of the capping movement of the first liquid discharge head from the discharge position P1 to the capped position P2 and the discharge position movement of the first liquid discharge head from the capped position P2 to the discharge position P1 by elastic force. The driver 71 includes a drive source 53 that generates the driving force. The driver 64 performs the other of the capping movement of the first liquid discharge head and the discharge position movement of the first liquid discharge head by a driving force against elastic force.

With such a configuration, power for movement of the first liquid discharge head can be shared by the elastic member 70 and the drive source 53.

The liquid discharge unit 20 includes a unit mover 81. The unit mover 81 moves the movable unit 80 including the cap 60, the elastic member 66, and the driver 64 to the inside of the movement region R1 of the first liquid discharge head and the outside of the movement region R1.

With such a configuration, it is possible to prevent the movable unit 80 from hindering the movement of the first liquid discharge head.

In the present embodiment, the elastic member 70 moves the liquid discharge head 22 from the discharge position P1 to the capped position P2 by the elastic force, and the driver 71 moves the liquid discharge head 22 from the capped position P2 to the discharge position P1. However, the present embodiment is not limited thereto. For example, the driver 71 may move the liquid discharge head 22 from the discharge position P1 to the capped position P2, and the elastic member 70 may move the liquid discharge head 22 from the capped position P2 to the discharge position P1 by elastic force.

### Third Embodiment

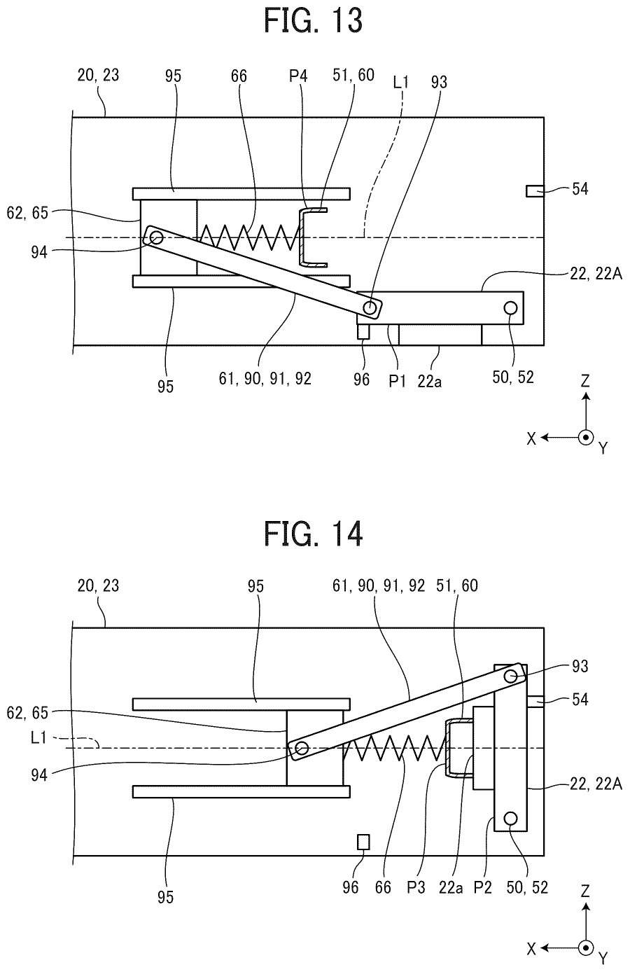

FIG. 13 is a view illustrating a part of the liquid discharge unit 20 of the third embodiment in a state in which the liquid discharge head 22 is located at the discharge position P1. FIG. 14 is a view illustrating a part of the liquid discharge unit 20 of the third embodiment in a state where the liquid discharge head 22 is located at the capped position P2.

As illustrated in FIGS. 13 and 14, the present embodiment is different from the first embodiment in the configuration of the liquid discharge unit 20. Hereinafter, differences from the first embodiment in the present embodiment will be mainly described.

The liquid discharge unit 20 of the present embodiment includes an interlocking mechanism 90. The interlocking mechanism 90 is included in the cap mover 61. The interlocking mechanism 90 is mounted on the carriage 23. The interlocking mechanism 90 moves the cap 60 to the capping position P3 to cover the liquid discharge head 22 at the capped position P2 in conjunction with the movement of the liquid discharge head 22 from the discharge position P1 to the capped position P2 by the head mover 50.

Specifically, the interlocking mechanism 90 includes a motion converter 91 (motion conversion mechanism). The motion converter 91 converts rotational motion of the liquid discharge head 22 into linear motion of the cap 60.

The motion converter 91 is a link mechanism. The motion converter 91 includes a lever member 92 and a liquid discharge head 22 as a link. One end of the lever member 92 is connected to the liquid discharge head 22 via a rotation shaft 93. The rotation shaft 93 is coupled to an end (end on the +X direction side) opposite to the end where the rotation shaft 52 is provided in the liquid discharge head 22 at the discharge position P1 (FIG. 13). The rotation shaft 93 connects the lever member 92 and the liquid discharge head 22 so as to be relatively rotatable. The other end of the lever member 92 is connected to the base member 65 of the head support 62 via the rotation shaft 94. The rotation shaft 94 connects the lever member 92 and the base member 65 so as to be relatively rotatable.

In the above configuration, as the liquid discharge head 22 moves by rotation from the discharge position P1 (FIG. 13) to the capped position P2 (FIG. 14), the lever member 92 moves the base member 65 in the −X direction, and the cap 60 is moved to the capping position P3 (FIG. 14). At this time, the base member 65 moves on the straight line L1 in the −X direction while being guided by two guides 95 provided in the carriage 23. The liquid discharge head 22 hits the stopper 54 at the capped position P2. Thus, the movement of the liquid discharge head 22 is restricted, and the liquid discharge head 22 is located at the capped position P2 (FIG. 14). When the liquid discharge head 22 moves from this state to the discharge position P1 (FIG. 13) by rotation, the lever member 92 moves the base member 65 in the +X direction according to this movement, and the cap 60 is moved to the open position P4. The liquid discharge head 22 hits the stopper 96 at the discharge position P1. Thus, the movement of the liquid discharge head 22 is restricted, and the liquid discharge head 22 is located at the discharge position P1 (FIG. 13).

As described above, the liquid discharge unit 20 of the present embodiment includes the interlocking mechanism 90. The interlocking mechanism 90 is mounted on the carriage 23. The interlocking mechanism 90 moves the cap 60 to the capping position P3 to cover the first liquid discharge head at the capped position P2 in conjunction with the movement of the first liquid discharge head from the discharge position P1 to the capped position P2 by the head mover 50.

With such a configuration, the movement of the cap 60 can be interlocked with the movement of the first liquid discharge head.

In addition, the interlocking mechanism 90 includes a motion converter 91. The motion converter 91 converts rotational motion of the first liquid discharge head into linear motion of the cap 60.

With such a configuration, the cap 60 can be linearly moved using the rotational movement of the first liquid discharge head. According to the above configuration, a dedicated drive source (the drive source 68 of the first embodiment) for the cap 60 is unnecessary.

The motion converter 91 is a link mechanism including the first liquid discharge head as a link.

With such a configuration, since the liquid discharge head 22 is included in the motion converter 91 as a link, the configuration of the liquid discharge unit 20 can be simplified as compared with a configuration in which the motion converter 91 does not include the liquid discharge head 22.

### Other Embodiments

In each of the above embodiments, an example in which each of the multiple liquid discharge heads 22 may be the first liquid discharge head has been described, but the embodiments are not limited thereto. It is sufficient that at least one of the multiple liquid discharge heads 22 is the first liquid discharge head.

In each of the above embodiments, the multiple liquid discharge heads 22 is arranged in the multiple rows, but is not limited thereto. For example, the multiple liquid discharge heads 22 may be arranged as one example. In each of the above embodiments, the multiple liquid discharge heads 22 is arranged in three rows, but is not limited thereto. For example, the multiple liquid discharge heads 22 may be arranged in two rows, or may be arranged in four or more rows.

In each of the above embodiments, in the liquid discharge head 22, the multiple nozzles 22b is provided and the two rows of nozzles 22b are provided, but the embodiments are not limited thereto. For example, the number of rows of the nozzles 22b may be one or three or more. The number of nozzles 22b may be one.

In each of the above embodiments, the cap 60 is provided for all of the multiple liquid discharge heads 22, but the embodiments are not limited thereto. For example, in a case where the liquid of the multiple liquid discharge heads 22 includes one that is easy to dry and one that is difficult to dry, the cap 60 may be provided only for the liquid discharge head 22 that discharges the liquid that is easy to dry, and the cap 60 need not be provided for the liquid discharge head 22 that discharges the liquid that is difficult to dry. The liquid discharge head 22 not provided with the cap 60 need not be movable, and may be fixed to the carriage 23. As an example, since a pretreatment liquid discharged by the pretreatment head 22A is exemplified as a liquid that is difficult to dry, the cap 60 may not be provided for the pretreatment head 22A, and the pretreatment head 22A may be fixed to the carriage 23. Alternatively, a part of the liquid discharge heads 22 may be fixed to the carriage 23, a cap that can protect these liquid discharge heads 22 may be provided so as to be slidable with respect to the carriage, and the cap may cover the liquid discharge head 22.

The embodiments of the present disclosure are described above with reference to specific examples. However, the present disclosure is not limited to the above-described specific examples. The modified specific examples including the features of the present disclosure, in which a person skilled in the art appropriately implements a design change, are also included in the scope of the present disclosure. Each element included in each specific example described above and the arrangement, conditions, shape, and the like thereof are not limited to those exemplified, and can be appropriately changed. The respective elements included in the above-described specific examples can be appropriately combined with each other unless technically contradicted.

The term “liquid discharge head” used herein is a functional component to discharge liquid through the nozzles. Liquid to be discharged from the nozzles of the head is not limited to a particular liquid as long as the liquid has a viscosity or surface tension to be discharged from the head. However, preferably, the viscosity of the liquid is not greater than 30 mPa·s under ordinary temperature and ordinary pressure or by heating or cooling. Specific examples of such liquid include, but are not limited to, solutions, suspensions, and emulsions containing solvents such as water and organic solvents, colorants such as dyes and pigments, functionality imparting materials such as polymerizable compounds, resins and surfactants, biocompatible materials such as deoxyribonucleic acid (DNA), amino acid, protein and calcium, and/or edible materials such as natural colorants. Such liquid can be used as inkjet inks, surface treatment liquid, liquid for forming compositional elements of electronic or luminous elements or electronic circuit resist patterns, and three-dimensional object forming material liquid.

Examples of an energy source for generating energy to discharge liquid include a piezoelectric actuator (a laminated piezoelectric element or a thin-film piezoelectric element), a thermal actuator that employs an electrothermal conversion element, such as a heating resistor (element), and an electrostatic actuator including a diaphragm and opposed electrodes.

The “liquid discharge unit” includes the liquid discharge head with functional components and mechanisms integrated, and is an assembly of components related to the liquid discharge. For example, the “liquid discharge unit” includes a combination of the liquid discharge head with at least one of a head tank, a carriage, a supply mechanism, a maintenance recovery mechanism, or a main scanning mover.

Here, the integration includes, for example, a configuration in which the liquid discharge head, the functional components, and the mechanisms are fixed to each other by fastening, adhesion, engagement, or the like, and a configuration in which one is movably held with respect to the other. The liquid discharge head and the functional components or mechanisms may be detachably attached to each other.

For example, the liquid discharge head and the head tank are integrated to form the liquid discharge unit as a single unit. Alternatively, the liquid discharge head and the head tank coupled (connected) to each other via, for example, a tube may form the liquid discharge unit as a single unit. Here, it is also possible to add a unit including a filter between the head tank and the liquid discharge head of these liquid discharge units.

Further, as the liquid discharge unit, there is a unit in which a liquid discharge head and a carriage are integrated.

The liquid discharge head is movably held on the guide that constitutes a part of the scanning mover. Thus, the liquid discharge head and the scanning mover may be integrated to be the liquid discharge unit. The liquid discharge unit may include the liquid discharge head, the carriage, and the main scanning mover that are integrated as a single unit.

A cap that forms a portion of the maintenance recovery mechanism may be secured to the carriage to which the liquid discharge head is attached, so that the liquid discharge head, the carriage, and the maintenance recovery mechanism are integrated to be the liquid discharge unit.

The liquid discharge unit may include a tube coupled to the head tank or the liquid discharge head mounting a channel part, so that the liquid discharge head and the supply mechanism form a single unit. Liquid of a liquid storage source is supplied to the liquid discharge head through the tube.

The main scanning mover may be a guide alone. The supply mechanism may be a single tube alone or a single loading unit alone.

In the present application, the “liquid discharge apparatus” includes the liquid discharge head or the liquid discharge unit and drives the liquid discharge head to discharge a liquid. The liquid discharge apparatus may be, for example, an apparatus that can discharge liquid to a material to which liquid can adhere or an apparatus that discharges liquid toward gas or into liquid.

The “liquid discharge apparatus” may also include a unit related to feeding, conveying, and sheet ejection of a material to which liquid can adhere, a preprocessing apparatus, a post-processing apparatus, and the like.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

In addition, the “liquid discharge apparatus” is not limited to an apparatus in which a meaningful image such as a character or a figure is visualized by the discharged liquid. For example, the liquid discharge apparatus may be an apparatus that forms patterns having no meaning or an apparatus that fabricates three-dimensional images.

The “material to which liquid can adhere” means an object to which liquid can at least temporarily adhere, an object to which liquid adheres and is fixed, an object to which liquid adheres and permeates, or the like. As detailed examples, the material may be a medium including a recording medium such as paper, a recording sheet, recording paper, a film, cloth, and the like, an electronic part such as an electronic substrate, a piezoelectric element, and the like, a powder material layer (powder layer), an organ model, an inspection cell, and the like, and any liquid adherable material can be included unless a specific limitation is applied.

The material of the “material to which liquid can adhere” may be any material as long as liquid can adhere even temporarily, such as paper, thread, fiber, cloth, leather, metal, plastic, glass, wood, or ceramics.

The term “liquid” includes any liquid having a viscosity or a surface tension that is dischargeable from the head. However, preferably, the viscosity of the liquid is not greater than 30 mPa·s under ordinary temperature and ordinary pressure or by heating or cooling. Specific examples of such liquid include, but are not limited to, solutions, suspensions, and emulsions containing solvents such as water and organic solvents, colorants such as dyes and pigments, functionality imparting materials such as polymerizable compounds, resins and surfactants, biocompatible materials such as deoxyribonucleic acid (DNA), amino acid, protein and calcium, and/or edible materials such as natural colorants. Such liquid can be used as inkjet inks, surface treatment liquid, liquid for forming compositional elements of electronic or luminous elements or electronic circuit resist patterns, and three-dimensional object forming material liquid.

The “liquid discharge apparatus” may be an apparatus to relatively move the liquid discharge head and a material to which liquid can adhere. However, the liquid discharge apparatus is not limited to such an apparatus. Specific examples include a serial type apparatus which moves the liquid discharge head, and a line type apparatus which does not move the liquid discharge head.

Examples of the “liquid discharge apparatus” further include a treatment liquid coating apparatus to discharge a treatment liquid to a sheet to coat the treatment liquid on the surface of the sheet to reform the sheet surface and an injection granulation apparatus in which a composition liquid including raw materials dispersed in a solution is injected through nozzles to granulate fine particles of the raw materials.

A liquid discharge unit (20) includes: a first head (22) having a first nozzle face having first nozzles on the first nozzle face, the first head configured to discharge a liquid from the first nozzles in a discharge direction, a second head (22) having a second nozzle face having second nozzles on the second nozzle face, the second head configured to discharge a liquid from the second nozzles in the discharge direction, one carriage (23) configured to: mounting the first head and the second head; and movable in a main scanning direction orthogonal to the discharge direction; and a first cap (60), in the one carriage (23), configured to cap the first nozzle face of the first head (22); and a second cap (60), in the one carriage (23), configured to cap the second nozzle face of the second head (22), wherein the first head and the second head are independently movable between: a discharge position at which at least one of the first head or the second head discharges the liquid in the discharge direction; and a capped position at which at least one of the first cap or the second cap caps the first head or the second head.

The liquid discharge unit (20) further includes: a head mover (50) on the carriage (23), and the head mover configured to: move the first head to the discharge position or the capped position independently from moving the second head to the discharge position or the capped position. The first head (22) is configured to discharge a first type of liquid from the first nozzles; and the second head (22) is configured to discharge a second type of liquid different from the first type of liquid from the second nozzles; and the head mover (50) is further configured to: move the first head to the discharge position to discharge the first type of the liquid from the first nozzles; move the first head to the capped position to cap the first nozzle face with the first cap; move the second head to the discharge position independently from the first head to discharge the second type of the liquid from the second nozzles; and move the second head to the capped position independently from the first head to cap the second nozzle face with the second cap.

The liquid discharge unit (20) further includes: a first head unit (25) including first multiple heads including the first head (22), the first multiple heads arranged in the main scanning direction; a second head unit (25) including second multiple heads including the second head (22), the first multiple heads arranged in the main scanning direction; a first cap unit (25) disposed adjacent to the first head unit in the main scanning direction, the first cap unit including first multiple caps including the first cap, the first multiple caps respectively caps the first multiple heads; and a second cap unit (25) disposed adjacent to the second head unit in the main scanning direction, the second cap unit including second multiple caps including the second cap, the second multiple caps respectively caps the second multiple heads, wherein the first head unit is separated from the second head unit in a sub-scanning direction orthogonal to the main scanning direction and the discharge direction, the head mover (50) is further configured to: move the first head unit to the discharge position to discharge the first type of the liquid from the first nozzles, while moving the second head unit to the capped position to cap the second nozzle face with the second cap; and move the second head unit to the discharge position independently from the first head unit to discharge the second type of the liquid from the second nozzles, while moving the first head unit to the capped position independently from the second head unit to cap the first nozzle face with the first cap.

The head mover (50) is further configured to rotate the first head between the discharge position and the capped position. The head mover (50) includes: a first rotation shaft couple to the first head and rotatably supported by the one carriage; a second rotation shaft couple to the second head and rotatably supported by the one carriage; a first drive source configured to rotate the first head about the first rotation shaft between the discharge position and the capped position; and a second drive source configured to rotate the second head about the second rotation shaft between the discharge position and the capped position.

The head mover (50) is further configured to: reciprocally and linearly moves the first head between the discharge position and the capped position; and reciprocally and linearly moves the second head between the discharge position and the capped position.

The liquid discharge unit (20) further includes: a cap mover including: a first cap mover (61) including: a first elastic member configured to press the first cap in one direction; and a first driver configured to move the first cap in another direction opposite to the one direction against a pressing force of the first elastic member; and a second cap mover (61) including: a second elastic member configured to press the second cap in one direction; and a second driver configured to move the second cap in another direction opposite to the one direction against a pressing force of the second elastic member.

The liquid discharge unit (20) further includes: a first interlocking mechanism (90), on the carriage (23), configured to move the first cap (60) between: a capping position to cap the first nozzle face of the first head at the capped position; and a separation position at which the cap is separated from the first nozzle face of the first head, according to a movement of the first head between the capped position and the discharge position by the head mover; and a second interlocking mechanism (90), on the carriage (23), configured to move the second cap (60) between: a capping position to cap the second nozzle face of the second head at the capped position; and a separation position at which the cap is separated from the second nozzle face of the second head, according to a movement of the second head between the capped position and the discharge position by the head mover.

The head mover (50) is further configured to rotate the first head to move the first head between the discharge position and the capped position, the first cap (60) moves linearly between the capping position and the separation position with respect to the first head at the capped position, and the first interlocking mechanism (90) is further configured to convert rotational motion of the first head into linear motion of the first cap (60); and the head mover (50) is further configured to rotate the second head to move the second head between the discharge position and the capped position, the second cap (60) moves linearly between the capping position and the separation position with respect to the second head at the capped position, and the second interlocking mechanism (90) is further configured to convert rotational motion of the second head into linear motion of the second cap (60). The first interlocking mechanism (90) includes a first link linking the first head and the first cap; and the second interlocking mechanism (90) includes a second link linking the second head and the second cap.

The liquid discharge unit (20) further includes: a first cap mover (61) configured to move the first cap (60) between: a sealing position at which the first cap (60) caps the first nozzles of the first head; and an open position at which the first cap (60) is separated from the first nozzle face; and a second cap mover (61) configured to move the second cap (60) independently from the first cap mover between: a sealing position at which the second cap (60) caps the first nozzles of the first head; and an open position at which the second cap (60) is separated from the second nozzle face.

The first cap mover (61) includes: a first elastic member configured to press the first cap in one direction; and a first driver configured to move the first cap in another direction opposite to the one direction against a pressing force of the first elastic member; and the second cap mover (61) includes: a second elastic member configured to press the second cap in one direction; and a second driver configured to move the second cap in another direction opposite to the one direction against a pressing force of the second elastic member.

The liquid discharge unit (20) further includes: a first cap unit including the first cap (60), the first elastic member, and the first driver; and a second cap unit including the second cap (60), the second elastic member, and the second driver, wherein the first head moves within a first head region, the second head moves within a second head region, the first cap mover (81) is further configured to move the first cap unit inside the first head region or outside the first head region, and the second cap mover (81) is further configured to move the second cap unit inside the second head region or outside the second head region.

The first cap mover (61) includes a first elastic member configured to apply elastic force to the first cap (60) at the sealing position to press the first cap (60) against the first head at the capped position; and the first cap mover (61) includes a second elastic member configured to apply elastic force to the second cap (60) at the sealing position to press the second cap (60) against the second head at the capped position. The first head (22) is configured to discharge a first type of liquid from the first nozzles; and the second head (22) is configured to discharge a second type of liquid different from the first type of liquid from the second nozzles. The discharge position is a position where the first nozzles or the second nozzles face a target object, and the capped position is a position where the first nozzles or the second nozzles are more separated from the target object than when the first head or the second head (22) is located at the discharge position.

A liquid discharge apparatus (1) includes: the liquid discharge unit (20) according to any one of claims 1 to 17; and a control unit configured to control the liquid discharge unit (20).

Aspects of the present disclosure are, for example, as follows.

According to Aspect 1, a liquid discharge unit includes:
one carriage movable with respect to a guide included in a device on which the liquid discharge unit is mounted;
multiple liquid discharge heads each including a discharge port capable of discharging liquid, mounted on the carriage, and configured to discharge the liquid from the discharge port to a target object at a discharge position; and
a cap provided in the carriage and capable of covering the discharge port of at least one of the liquid discharge heads,
a first liquid discharge head among the multiple liquid discharge heads being movable independently of a second liquid discharge head different from the first liquid discharge head among the multiple liquid discharge heads to the discharge position and a capping position that is a position different from the discharge position and at which the discharge port is covered by the cap.

According to Aspect 2, the liquid discharge unit of Aspect 1 further includes:
a head mover mounted on the carriage and configured to move the first liquid discharge head to the discharge position and the capping position independently of the second liquid discharge head.

According to Aspect 3, in the liquid discharge unit of Aspect 2,
the multiple liquid discharge heads performs a printing operation including multiple steps of discharging the liquid onto the target object, and
the head mover positions the first liquid discharge head at the discharge position in a case of the step in which the first liquid discharge head discharges the liquid, and positions the first liquid discharge head at the capping position in a case of the step in which the first liquid discharge head does not discharge the liquid.

According to Aspect 4, the liquid discharge unit of Aspect 2 further includes:
multiple head units each including one or more of the liquid discharge heads,
in which the multiple liquid discharge heads is included in any one of the head units, and performs a printing operation of discharging the liquid onto the target object,
the multiple head units selectively performs a discharge operation of discharging the liquid from the liquid discharge heads in the printing operation, and
the head mover is provided in the head unit including the first liquid discharge head, and positions the first liquid discharge head at the discharge position in a case where the head unit performs the discharge operation, and positions the first liquid discharge head at the capping position in a case where another of the head units performs the discharge operation.

According to Aspect 5, in the liquid discharge unit of Aspect 2,
the head mover moves the first liquid discharge head to the discharge position and the capping position by rotating the first liquid discharge head about an axis extending in a direction intersecting an opposing direction of the first liquid discharge head and the target object at the discharge position.

According to Aspect 6, in the liquid discharge unit of Aspect 5, the head mover includes:
a rotation shaft coupled to the first liquid discharge head and rotatable integrally with the first liquid discharge head about the axis; and
a drive source configured to rotate the rotation shaft to move the first liquid discharge head to the discharge position and the capping position.

According to Aspect 7, in the liquid discharge unit of Aspect 2,
the head mover moves the first liquid discharge head to the discharge position and the capping position by reciprocating the first liquid discharge head on a straight line.

According to Aspect 8, in the liquid discharge unit of Aspect 7, the head mover includes:
an elastic member configured to perform one of a capping movement of the first liquid discharge head from the discharge position to the capping position and a discharge position movement of the first liquid discharge head from the capping position to the discharge position by elastic force; and
a driver including a drive source configured to generate driving force, the driver being configured to perform the other of the capping movement of the first liquid discharge head and the discharge position movement of the first liquid discharge head by the driving force against the elastic force.

According to Aspect 9, the liquid discharge unit of Aspect 2 further includes:
an interlocking mechanism mounted on the carriage and configured to move the cap to a capping position to cover the first liquid discharge head at the capping position in conjunction with movement of the first liquid discharge head from the discharge position to the capping position by the head mover.

According to Aspect 10, in the liquid discharge unit of Aspect 9,
the head mover moves the first liquid discharge head to the discharge position and the capping position by rotating the first liquid discharge head about an axis extending in a direction intersecting an opposing direction of the first liquid discharge head and the target object at the discharge position,
the cap moves on a straight line with respect to the first liquid discharge head located at the capping position to move to the capping position and an open position separated from the discharge port, and
the interlocking mechanism includes a motion conversion mechanism configured to convert rotational motion of the first liquid discharge head into linear motion of the cap.

According to Aspect 11, in the liquid discharge unit of Aspect 10,
the motion converter is a link mechanism including the first liquid discharge head as a link.

According to Aspect 12, the liquid discharge unit of Aspect 1 further includes
a cap mover configured to move the cap to a capping position at which the cap covers the discharge port of the first liquid discharge head located at the capping position and an open position at which the cap is more separated from the first liquid discharge head at the capping position than when at the capping position.

According to Aspect 13, in the liquid discharge unit of Aspect 12, the cap mover includes:
an elastic member configured to perform one of an open position movement of the cap from the capping position to the open position and a capping movement of the cap from the open position to the capping position by elastic force; and
a driver including a drive source configured to generate driving force, the driver being configured to perform the other of the open position movement of the cap and the capping movement of the cap by the driving force against the elastic force.

According to Aspect 14, the liquid discharge unit of Aspect 13 further includes:
a unit mover configured to move a movable unit including the cap, the elastic member, and the driver to an inside of a movement region of the first liquid discharge head and an outside of the movement region.

According to Aspect 15, in the liquid discharge unit of Aspect 12,
the cap mover includes an elastic member configured to press the cap at the capping position against the first liquid discharge head located at the capping position by elastic force.

According to Aspect 16, in the liquid discharge unit of Aspect 1,
the liquid discharged from one of the liquid discharge heads is different from the liquid discharged from at least one of the other liquid discharge heads.

According to Aspect 17, in the liquid discharge unit of Aspect 1,
the discharge position is a position where the discharge port faces the target object, and
the capping position is a position where the discharge port is more separated from the target object than when the liquid discharge head is located at the discharge position.

According to Aspect 18, a liquid discharge apparatus includes:
the liquid discharge unit according to any one of Aspects 1 to 17; and
a control unit configured to control the liquid discharge unit.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge unit comprising:
a first head having a first nozzle face having first nozzles on the first nozzle face,
the first head configured to discharge a liquid from the first nozzles in a discharge direction,
a second head having a second nozzle face having second nozzles on the second nozzle face,
the second head configured to discharge a liquid from the second nozzles in the discharge direction,
one carriage configured to:
mounting the first head and the second head; and
movable in a main scanning direction orthogonal to the discharge direction; and
a first cap, in the one carriage, configured to cap the first nozzle face of the first head; and
a second cap, in the one carriage, configured to cap the second nozzle face of the second head,
wherein the first head and the second head are independently movable between:
a discharge position at which at least one of the first head or the second head discharges the liquid in the discharge direction; and
a capped position at which at least one of the first cap or the second cap caps the first head or the second head.

2. The liquid discharge unit according to claim 1, further comprising:
a head mover on the carriage, and
the head mover configured to:
move the first head to the discharge position or the capped position independently from moving the second head to the discharge position or the capped position.

3. The liquid discharge unit according to claim 2,
wherein the first head is configured to discharge a first type of liquid from the first nozzles; and
the second head is configured to discharge a second type of liquid different from the first type of liquid from the second nozzles; and
the head mover is further configured to:
move the first head to the discharge position to discharge the first type of the liquid from the first nozzles;
move the first head to the capped position to cap the first nozzle face with the first cap;
move the second head to the discharge position independently from the first head to discharge the second type of the liquid from the second nozzles; and
move the second head to the capped position independently from the first head to cap the second nozzle face with the second cap.

4. The liquid discharge unit according to claim 3, further comprising:
a first head unit including first multiple heads including the first head, the first multiple heads arranged in the main scanning direction;
a second head unit including second multiple heads including the second head, the first multiple heads arranged in the main scanning direction;
a first cap unit disposed adjacent to the first head unit in the main scanning direction,
the first cap unit including first multiple caps including the first cap, the first multiple caps respectively caps the first multiple heads; and
a second cap unit disposed adjacent to the second head unit in the main scanning direction,
the second cap unit including second multiple caps including the second cap, the second multiple caps respectively caps the second multiple heads,
wherein the first head unit is separated from the second head unit in a sub-scanning direction orthogonal to the main scanning direction and the discharge direction,
the head mover is further configured to:
move the first head unit to the discharge position to discharge the first type of the liquid from the first nozzles,
while moving the second head unit to the capped position to cap the second nozzle face with the second cap; and
move the second head unit to the discharge position independently from the first head unit to discharge the second type of the liquid from the second nozzles,
while moving the first head unit to the capped position independently from the second head unit to cap the first nozzle face with the first cap.

5. The liquid discharge unit according to claim 2,
wherein the head mover is further configured to rotate the first head between the discharge position and the capped position.

6. The liquid discharge unit according to claim 5,
wherein the head mover includes:
a first rotation shaft couple to the first head and rotatably supported by the one carriage;
a second rotation shaft couple to the second head and rotatably supported by the one carriage;
a first drive source configured to rotate the first head about the first rotation shaft between the discharge position and the capped position; and
a second drive source configured to rotate the second head about the second rotation shaft between the discharge position and the capped position.

7. The liquid discharge unit according to claim 2,
wherein the head mover is further configured to:
reciprocally and linearly moves the first head between the discharge position and the capped position; and
reciprocally and linearly moves the second head between the discharge position and the capped position.

8. The liquid discharge unit according to claim 7, further comprising:
a cap mover including:
a first cap mover including:
a first elastic member configured to press the first cap in one direction; and
a first driver configured to move the first cap in another direction opposite to the one direction against a pressing force of the first elastic member; and
a second cap mover including:
a second elastic member configured to press the second cap in one direction; and
a second driver configured to move the second cap in another direction opposite to the one direction against a pressing force of the second elastic member.

9. The liquid discharge unit according to claim 2, further comprising:
a first interlocking mechanism, on the carriage, configured to move the first cap between:
a capping position to cap the first nozzle face of the first head at the capped position; and
a separation position at which the cap is separated from the first nozzle face of the first head,
according to a movement of the first head between the capped position and the discharge position by the head mover; and
a second interlocking mechanism, on the carriage, configured to move the second cap between:
a capping position to cap the second nozzle face of the second head at the capped position; and
a separation position at which the cap is separated from the second nozzle face of the second head,
according to a movement of the second head between the capped position and the discharge position by the head mover.

10. The liquid discharge unit according to claim 9,
wherein the head mover is further configured to rotate the first head to move the first head between the discharge position and the capped position,
the first cap moves linearly between the capping position and the separation position with respect to the first head at the capped position, and
the first interlocking mechanism is further configured to convert rotational motion of the first head into linear motion of the first cap; and
the head mover is further configured to rotate the second head to move the second head between the discharge position and the capped position,
the second cap moves linearly between the capping position and the separation position with respect to the second head at the capped position, and
the second interlocking mechanism is further configured to convert rotational motion of the second head into linear motion of the second cap.

11. The liquid discharge unit according to claim 10,
wherein the first interlocking mechanism includes a first link linking the first head and the first cap; and
the second interlocking mechanism includes a second link linking the second head and the second cap.

12. The liquid discharge unit according to claim 1, further comprising:
a first cap mover configured to move the first cap between:
a sealing position at which the first cap caps the first nozzles of the first head; and
an open position at which the first cap is separated from the first nozzle face; and
a second cap mover configured to move the second cap independently from the first cap mover between:
a sealing position at which the second cap caps the first nozzles of the first head; and
an open position at which the second cap is separated from the second nozzle face.

13. The liquid discharge unit according to claim 12,
wherein the first cap mover includes:
a first elastic member configured to press the first cap in one direction; and
a first driver configured to move the first cap in another direction opposite to the one direction against a pressing force of the first elastic member; and
the second cap mover includes:
a second elastic member configured to press the second cap in one direction; and
a second driver configured to move the second cap in another direction opposite to the one direction against a pressing force of the second elastic member.

14. The liquid discharge unit according to claim 13, further comprising:
a first cap unit including the first cap, the first elastic member, and the first driver; and
a second cap unit including the second cap, the second elastic member, and the second driver,
wherein the first head moves within a first head region,
the second head moves within a second head region,
the first cap mover is further configured to move the first cap unit inside the first head region or outside the first head region, and
the second cap mover is further configured to move the second cap unit inside the second head region or outside the second head region.

15. The liquid discharge unit according to claim 12,
wherein the first cap mover includes a first elastic member configured to apply elastic force to the first cap at the sealing position to press the first cap against the first head at the capped position; and
the second cap mover includes a second elastic member configured to apply elastic force to the second cap at the sealing position to press the second cap against the second head at the capped position.

16. The liquid discharge unit according to claim 1,
wherein the first head is configured to discharge a first type of liquid from the first nozzles; and
the second head is configured to discharge a second type of liquid different from the first type of liquid from the second nozzles.

17. The liquid discharge unit according to claim 1,
wherein the discharge position is a position where the first nozzles or the second nozzles face a target object, and
the capped position is a position where the first nozzles or the second nozzles are more separated from the target object than when the first head or the second head is located at the discharge position.

18. A liquid discharge apparatus comprising:
the liquid discharge unit according to claim 1; and
a control unit configured to control the liquid discharge unit.
